(19) United States
(12) Patent Application Publication
(10) Pub. No.: US 2025/0184861 A1
(43) Pub. Date: Jun. 5, 2025

(54) MANAGING A LINK ISSUE IN A SIDELINK RELAY SYSTEM

(71) Applicant: CANON KABUSHIKI KAISHA, Tokyo (JP)

(72) Inventors: Walaa SAHYOUN, RENNES (FR); Romain GUIGNARD, RENNES (FR); Pierre VISA, RENNES (FR); Pascal LAGRANGE, La Chapelle des Fougeretz (FR)

(21) Appl. No.: 18/842,695

(22) PCT Filed: Feb. 23, 2023
(86) PCT No.: PCT/EP2023/054589

§ 371 Date: Aug. 29, 2024

(30) Foreign Application Priority Data
Mar. 1, 2022 (GB) 2202813.8
May 25, 2022 (GB) 2207705.1

(51) Int. Cl. H04W 40/22; H04W 48/10; H04W 88/04

(52) U.S. Cl. CPC H04W 40/22; H04W 48/10; H04W 88/04

(57) ABSTRACT

A method for signalling a link issue in a wireless communication system comprising a relay UE node and a plurality of nodes is described. The relay UE node is configured to relay data between a first UE of the plurality of nodes and a second UE of the plurality of nodes. The method at the relay UE node includes: detecting a link issue associated with at least one of a first PC5 link established between the first UE and the relay node, and a second PC5 link established between the second UE and the relay node; after detecting the link issue, generating link issue feedback information for the detected link issue, the link issue feedback information including information for identifying a type of the detected link issue; sending the link issue feedback information to at least one of the first UE and the second UE.

### CROSS-REFERENCE TO RELATED APPLICATIONS

The application is the National Phase application of PCT Application No. PCT/EP2023/054589, filed on Feb. 23, 2023 and titled “MANAGING A LINK ISSUE IN A SIDELINK RELAY SYSTEM”. This application claims the benefit under 35 U.S.C. § 119(a)-(d) of United Kingdom Patent Application No. 2202813.8, filed on Mar. 1, 2022 and titled “MANAGING A LINK ISSUE IN A SIDELINK RELAY SYSTEM” and United Kingdom Patent Application No. 2207705.1, filed on May 25, 2022 and titled “MANAGING A LINK ISSUE IN A SIDELINK RELAY SYSTEM”. Each of the above cited patent applications are incorporated herein by reference in its entirety.

### FIELD OF THE INVENTION

The present invention generally relates to managing a link issue in a sidelink relay system and/or to signalling a link issue in a wireless communication system and particularly to methods performed at different nodes in a sidelink relay system, a method and device for signalling a link issue in a sidelink relay system and a method and device for processing link issue feedback information signalling a link issue in a sidelink relay system.

### BACKGROUND

The present invention relates to Vehicle-to-everything (V2X) communication, more precisely to New Radio (NR) Sidelink Relaying for coverage extension and power efficiency improvement.

Recent Cellular-vehicle-to-everything (C-V2X) technologies support intelligent transport system (ITS), in which all road users, including vehicles and pedestrians cooperate with each other via wireless communications, promising to increase the traffic efficiency (e.g. reduce traffic congestion) and improve road safety while avoiding road traffic accidents. The wireless communications aim at increasing the visibility of vehicles particularly in non-line-of-sight (NLOS) conditions, bad weather or high traffic density by exchanging messages between road users such as vehicles, Vulnerable Road users (VRU) (such as pedestrians, cyclists, etc.) or Road Side Units (RSU). C-V2X is studied in 4G LTE and 5G NR (New Radio) releases with specifications defined by 3GPP. The term V2X refers to “Vehicle to Everything” where a vehicle may establish communication with “everything” which refers to different network entities or user equipment (UE). The following communications are considered:
V2V or Vehicle-to-Vehicle communication for exchanging safety and advanced services information,
V2P or Vehicle-to-Pedestrian in order to send warnings for pedestrian,
V2I or Vehicle-to-Infrastructure such as Road Side Unit to provide road safety services,
V2N or Vehicle-to-Network connecting the vehicle to the cellular base station for real time traffic.

3GPP has been developing standards for UE-to-UE direct communication referred to as Sidelink (SL) communication, or PC5 communication (e.g. direct communication between UEs over a Sidelink or PC5 interface). The Sidelink (or PC5) communications have been first introduced in 3GPP Release 12, as part of the Proximity Service (ProSe) framework, intended for LTE technology. Later versions of Sidelink for LTE have mainly focused on use cases related to inter-vehicle communications (V2V), introducing basic safety messaging (BSM). It is noted that the term UE in UE-to-UE direct communication can refer to a UE of VRU (e.g. a UE of a pedestrian) or a UE in or part of a vehicle or a RSU.

The first version of Sidelink for 5G, or New Radio (NR) Sidelink, has been developed in Release 16 as part of the 5G V2X Work Item, to support advanced V2X scenarios and commercial applications and services in addition to complement former basic safety services.

NR V2X addresses advanced driving use cases where vehicles are exchanging large amount of data while respecting a low latency requirement. Thus, advanced V2X scenarios require ultra-reliability and low latency in order to cover high-speed and high-density scenarios along with network coverage extension, which may require some data relaying.

NR Sidelink is designed to provide three basic transmission scenarios: broadcast, groupcast and unicast communications, while considering both out-of-coverage and in-network coverage deployment scenarios.

In this respect, Sidelink relaying has been studied by 3GPP with the aim of providing Sidelink/network coverage extension along with power efficiency improvement, thus enabling a wider range of applications and services.

3GPP has approved a study Item “Study on NR Sidelink Relay” in Release 17 (Rel-17), which covers the enhancements and solutions necessary to support both UE-to-Network (U2N) and UE-to-UE (U2U) Sidelink Relaying, which is documented in 3GPP TR 38.836. The investigation covers discovery procedure, and both Layer-2 and Layer-3 UE-to-Network Relay and UE-to-UE Relay, including detailed aspects of relay (re)selection, authorization, QoS management, service continuity, security, protocol stack design and Control Plane (CP) procedure.

A new adaptation layer has also been considered by 3GPP for managing Layer 2 (L2) Sidelink Relaying. This Sidelink Relay Adaptation Layer (SRAP) is located on top of the RLC sublayer. SRAP is documented in 3GPP TS 38.351.

Further enhancements are foreseen for Release 18, including the support of UE-to-UE network Relay for Sidelink coverage extension purpose, as well as service continuity and multi-path communications.

NR Sidelink relaying has the particularity of relaying data from a source node to a destination or target node between two hops (e.g. two links). In the UE-to-Network (U2N) relaying case, the source node may be either a network node or base station (for 5G NR the base station is referred to as a gNB) in downlink case or a Remote UE in uplink case and respectively, the destination or target node is either a Remote UE or a gNB. In the UE-to-UE (U2U) relaying case, the source node is called source UE while the destination or target node is called target UE. A hop between two UEs (e.g. Remote UE and Relay UE) is a Sidelink PC5-hop while a hop between a gNB and a UE is a Uu hop. Therefore, for a UE-to-Network (U2N) relaying case, the hop, between a Remote UE and a Relay UE (in uplink) or between a Relay UE and Remote UE (in downlink), is a Sidelink PC5-hop while the other hop between the Relay UE and a gNB (in uplink) or between a gNB and a Relay UE (in downlink) is a Uu hop. And for a UE-to-UE (U2U) relaying case, the hop between the source UE and the relay UE and the hop between relay UE and target UE are Sidelink PC5-hops.

This partial visibility between the transmitter Tx (source) device (Remote UE or gNB or source UE) and the receiver Rx (destination) device (Remote UE or gNB or target UE), resulting from the presence of the Relay UE between the aforementioned two hops, may hide from one hop any issue that could occur on the other hop.

Different kinds of issues may occur in wireless communication. A first issue is congestion when the quantity of data to transmit over a hop exceeds the current capacity of the network, i.e. the resource/bandwidth available for the transmission. To allow Quality of Service differentiation in the Radio Access Network (RAN), the system uses different logical channels for the transmission of data of different priorities. Thereby, a differentiation of the resource allocation for each logical channel may also be performed according to the level of priority of the channel. Consequently, depending on the current capacity of the network and the QoS required for the data to be transmitted, congestion may occur on one or several particular channels. According to FIGS. 2a and 2b, representing the protocol stack of the User Plane for respectively, the UE-to-Network (U2N) relaying and the UE-to-UE (U2U) relaying, congestion may be detected at different level(s) in the protocol stack and thus congestion of a particular channel could be detected at a single radio bearer (RB) for a QoS flow or at ingress/egress Radio Link Control (RLC) channels of the corresponding hop. In more critical cases, a global congestion may occur and thus all radio bearers and RLC channels are impacted.

Other issues could happen on the link, related to the propagation environment such as an attenuation of RF signals because of objects, bad weather . . . and to the mobility of user equipment, that may significantly decrease the signal strength especially when using millimeter wave signals for high throughput. This problem causes a link degradation or a Radio Link Failure (RLF) at the corresponding hop.

As discussed above, RAN links may suffer from different problems. These problems can generate consecutive loss of data and an increase of latency that leads to the degradation of the Quality-of-Service (QoS). The link issue derived from these problems can be a congestion detected at the relay UE, a link degradation or a radio link failure. The congestion may occur at a radio bearer or an RLC channel or can affect a group of RLC channels.

A link issue detected at a first hop is recognized by the impacted node and the relay UE (i.e. the impacted node is connected to the relay UE by the first hop). However, the second node (e.g. another remote UE or gNB connected to the relay UE) on the second hop is not informed of the link issue and thus, the link issue affects the transmission or reception of traffic at the second node. And vice versa when a link issue is detected on the second hop, the impacted node on the first hop is not informed. This partial visibility of the relayed traffic may induce a consecutive amount of re-transmission request with a degradation of the QoS and may amplify the link issue to impact other bearers or channels.

Accordingly, solutions to at least one of the issues listed above are desirable.

### SUMMARY

In accordance with a first aspect of the present invention, there is provided a method for signalling a link issue in a wireless communication system. The wireless communication system comprises a relay User Equipment, UE, node and a plurality of nodes, where the plurality of nodes include a plurality of UEs. The relay UE node is configured for relaying data between a first UE of the plurality of nodes and a second UE of the plurality of nodes. The method at the relay UE node includes:
after detecting a link issue associated with at least one of a first PC5 link established between the first UE and the relay node, and a second PC5 link established between the second UE and the relay node, providing link issue feedback information for the detected link issue, the link issue feedback information including flow information for identifying a type of the detected link issue;
sending the link issue feedback information to at least one of the first UE and the second UE.

The link issue feedback information may include flow information for identifying one or more communication flows impacted by the detected link issue.

The link issue feedback information may be sent to at least one of the plurality of nodes associated with one or more communication flows impacted by the detected link issue. For example, the link issue feedback information may be sent to at least one of the plurality of nodes impacted by detected link issue. The link issue feedback information may be sent to at least one of a source node and a destination node.

In an example, the link issue feedback information may be sent to all of the plurality of nodes connected to the relay UE.

The plurality of nodes may include at least two remote UEs. The plurality of nodes may include at least two remote UEs and a network node, such as a gNB.

In accordance with a second aspect, there is provided a method for processing link issue feedback information at a first UE in a wireless communication system, the link issue feedback information signalling a link issue in the wireless communication system. The wireless communication system comprises the first UE, a relay UE node and a second UE, the relay UE node being configured for relaying data between the first UE and the second UE using PC5 links. The method includes:
receiving link issue feedback information from the relay UE node, the link issue feedback information including information for identifying a type of a detected link issue associated with at least one of a first PC5 link established between the first UE and the relay UE node, and a second PC5 link established between the second UE and the relay UE node and for the at least one of the first PC5 link and the second PC5 link associated with the detected link issue, an identifier of the UE connected to the PC5 link associated with the detected link issue;
processing the link issue feedback information to determine the detected link issue and one or more communication flows impacted by the detected link issue;
based on the detected link issue, taking an action at the first UE.

The link issue feedback information may further include flow information. In an example, the flow information includes a flow identifier for identifying the one or more communication flows impacted by the detected link issue. The identifier may be one of the following (e.g. based on the type of link issue): DRB ID; SRB ID; SL DRB ID; SL SRB ID; RLC bearer ID; RLC channel ID; link ID (e.g. PC5 ID or Uu ID) for identifying a link associated with the detected link issue.

The link issue is one of the following types of link issue: handover, congestion, link degradation, RLF, transient/short-term or long-term/permanent). The information for identifying a type of the detected link issue may include a reason identifier (ID) or another identifier for identifying a type of the detected link issue. The information may also include reason/context information for indicating a reason for or context of the detected link issue. The reason ID may, in addition to identifying the type of the detected link issue, also represent a reason for or context of the detected link issue as discussed above.

In an example, the link issue feedback information is included in a link issue signalling message that is sent by the relay UE node. The link issue feedback information may further include information for indicating a type of the link issue signalling message. For example, the type may be one of: a link issue feedback type; a (re)selection feedback type; or a link status modification feedback type and the information may be included in an Information Element (e.g. PDU type) of the message.

By generating link issue feedback information including flow information for identifying one or more communication flows impacted by the detected link issue, and sending the link issue feedback information to at least one of the plurality of nodes associated with the one or more communication flows impacted by the detected link issue (e.g. an impacted node which may be at least a source node or transmitter configured for data transmission and which may be a remote UE or a network node), impacted nodes in the sidelink relay connection or path (e.g. including the ‘hidden’ node) can be informed of the detected link issue and the impacted nodes can take appropriate action. The action at the impacted node may include, for example, releasing a link associated with the one or more impacted communication flows and performing (re)selection, waiting for new link issue feedback information, restarting transmission of data over the impacted one or more communication flows. This means that consecutive amount of re-transmission request with a degradation of the QoS when there is a link issue, and which may amplify the link issue to impact other bearers or channels, can be avoided.

By including a flow identifier for identifying the one or more communication flows impacted by the detected link issue, and in some cases, information for identifying the type of the detected link issue (and may be also including a reason for the link issue), the relay UE node can provide feedback information which identifies the granularity of the link issue problem which can help the impacted node(s) take an action that is optimum for the detected link issue (i.e. the impacted node(s) can take action promptly with details of the link issue to smartly adapt their behaviour).

The information (e.g. PDU type) indicating the type of the link issue signalling message helps to indicate to the node receiving the link issue signalling message one or more actions to be taken. By including information for indicating a type of the link issue signalling message with the link issue feedback information (flow identifier, information for identifying the type of the detected link issue), the link issue signalling message can have the same format for different link issues. In other words, the link issue signalling message can have the same format whether the link issue signalling message is signalling a link issue feedback or a (re)selection feedback or a link status modification feedback. The PDU type information and the link issue feedback information can be used by the node receiving the link issue signalling message to determine what actions should be taken.

In summary, methods are proposed for a sidelink relay system for reducing the link issue perturbation while ensuring the QoS of the relayed traffic.

In accordance with another aspect of the present invention, there is provided an apparatus for a relay UE node for a wireless communication system (e.g. for a sidelink relay system of a wireless communication system). The relay UE node is configured for relaying data between a first UE of a plurality of UEs of the wireless communication system and a second UE of the plurality of UEs using PC5 links established with the relay UE node. The apparatus comprises: one or more processing units configured to: after detecting a link issue associated with at least one of a first PC5 link established between the first UE and the relay UE node, and a second PC5 link established between the second UE and the relay UE node, provide link issue feedback information for the detected link issue, the link issue feedback information including information for identifying a type of the detected link issue; send the link issue feedback information to at least one of the first UE and the second UE.

In accordance with another aspect of the present invention, there is provided an apparatus for a first UE for a wireless communication system (e.g. for a sidelink relay system of a wireless communication system). The apparatus comprises: one or more processing units configured to: receive, from a relay UE node for relaying data between the first UE and a second UE using PC5 links, link issue feedback information, the link issue feedback information including information for identifying a type of a detected link issue associated with at least one of a first PC5 link established between the first UE and the relay UE node, and a second PC5 link established between the second UE and the relay UE node and for the at least one of the first PC5 link and the second PC5 link associated with the detected link issue, an identifier of the UE connected to the PC5 link associated with the detected link issue; process the link issue feedback information to determine the detected link issue and one or more communication flows impacted by the detected link issue; based on the detected link issue, take an action at the first UE.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by a processing unit, cause the processing unit to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram illustrating a Sidelink relay arrangement with UE-to-network based relaying and UE-to-UE based relaying;

FIG. 2a is a schematic diagram depicting the user plane Sidelink (SL) relay architecture for UE-to-network with the adaptation layer in accordance with 3GPP TR 38.836;

FIG. 2b is a schematic diagram depicting the user plane Sidelink (SL) relay architecture for UE-to-UE with the adaptation layer in accordance with 3GPP TR 38.836;

FIG. 3 is a schematic diagram illustrating a 1:1 mapping between radio bearers (RBs) and PC5 RLC channels and the N:1 mapping at Uu SRAP to the Uu RLC channels for UE-to-network Sidelink Relay;

FIG. 4 is a schematic diagram illustrating a N:1 and a 1:1 mapping between radio bearers (RBs) and PC5 RLC channels and a N:1 mapping at PC5 SRAP to the PC5 RLC channels for UE-to-UE Sidelink Relay;

FIG. 5 is a schematic diagram illustrating an example format of a link issue signalling message in accordance with embodiments of the invention;

FIG. 6a is a flow diagram of an example method for detecting a link issue and generating link issue feedback information at a relay node in accordance with embodiments of the invention;

FIG. 6b is a flow diagram of an example method for processing link issue feedback information at an impacted node according to embodiments of the invention;

FIG. 7a is a flow diagram of an example method, at the relay node, for generating a link issue signalling message including information for indicating relay (re)selection feedback in accordance with embodiments of the invention;

FIG. 7b is a flow diagram of an example method, at an impacted node, for processing information included in a link issue signalling message generated by the method described with respect to FIG. 7a according to embodiments of the invention;

FIG. 8a is a flow diagram of an example method, at the relay node, for generating a link issue signalling message including information for indicating link status modification feedback in accordance with embodiments of the invention;

FIG. 8b is a flow diagram of an example method, at an impacted node, for processing information included in a link issue signalling message generated by the method described with respect to FIG. 8a according to embodiments of the invention;

FIG. 9 is a flow diagram of an example method for signalling a link issue in a sidelink relay system according to embodiments of the invention;

FIG. 10 is a flow diagram of an example method for processing link issue feedback information at an impacted node in a sidelink relay system after receiving the feedback from the relay UE according to embodiments of the invention;

FIGS. 11a-11e are schematic diagrams illustrating example formats of a link issue signalling message in accordance with embodiments of the invention;

FIG. 12 is a block schematic diagram of an example wireless communication device in accordance with embodiments of the present invention;

FIG. 13 is a flow diagram of an example method performed at a relay UE node in accordance with embodiments of the invention;

FIGS. 14a and 14b are flow diagrams of example methods performed at a remote UE node according to embodiments of the invention.

### DETAILED DESCRIPTION

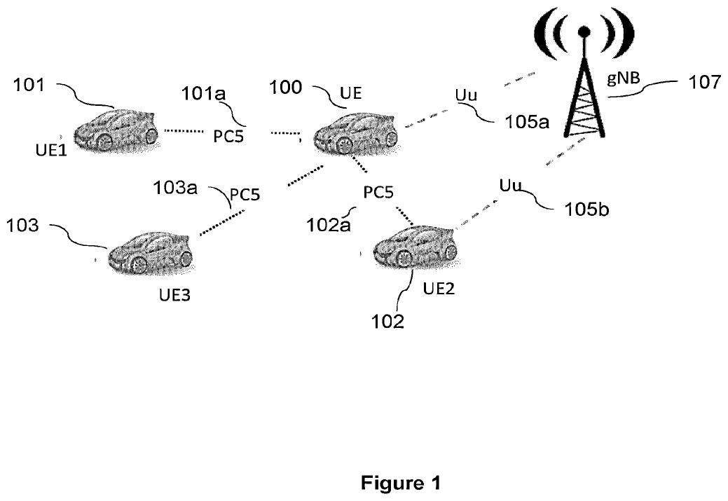

FIG. 1 represents an example of a wireless communication system capable of supporting Sidelink Relay and shows a sidelink relay arrangement or system including a relay User Equipment (UE) node and a plurality of nodes. The relay UE node relays data between at least one of the plurality of nodes and at least one other of the plurality of nodes. For example, in FIG. 1, UE node 100 may operate as a relay UE node relaying data between one of the UE nodes 101, 102, 103 (referred to as remote UE nodes) and the network node 107, in a UE-to-network relay case and/or may operate as a relay UE node relaying data between one of the UE nodes 101, 102, 103 (referred to as remote UE nodes) and another one of the UE nodes 101, 102, 103 in a UE-to-UE relay case. UE node 102 may also operate as relay node (for example, relaying data between the UE 100 (a remote UE node in this case) and the network node 107 and between UEs 100, 101, 103 over PC5 connections (some of which are not shown in FIG. 1). Thus, as shown in FIG. 1, the relay UE node (100 or 102) may be a UE-to-Network relay or a UE-to-UE relay or both at the same time.

The plurality of nodes may include at least two remote UE nodes (three remote UE nodes 101, 102, 103 are shown in FIG. 1 where UE node 100 is a relay node) and may also include a network node 107. The network node 107 may be a base station of a wireless network, such as a fifth-generation (5G) New Radio (NR) network or a Long Term Evolution (LTE) network. FIG. 1 only shows the base station of the wireless network for clarity. For a 5G NR network, the network node 107 is referred to as a gNB. Although FIG. 1 (and some of the other figures) shows the UE nodes represented by a vehicle, it is not intended that the invention is limited to UE nodes that are in or part of a vehicle. Each of the UE nodes (relay or remote) may be a wireless communication device located in or part of a vehicle or a Road Side Unit (RSU) or a wireless communication device of a Vulnerable Road User (VRU) (e.g. a mobile or portable communication device (such as a smart phone, PDA, laptop, or similar devices) of a pedestrian or cyclist). In the following, a relay UE node will also be referred to as a relay UE, a remote UE node will also be referred to as a remote UE and a network node will be referred to as a gNB. Although in the following description, embodiments and examples of embodiments of the present invention will be described with respect to a 5G NR network, it will be appreciated that it is not intended that the present invention is limited to 5G NR systems and may be used in any wireless communication systems supporting sidelink (or peer to peer) relay communications.

In an example shown in FIG. 1, in a UE-to-Network (or U2N) scenario with the UE 100 operating as a UE-to-Network relay UE, the UE-to-Network relay UE 100 connects the UEs 101, 102 and 103 operating as remote UEs to the gNB 107. The remote UE1 101 is connected to the relay UE 100 through a PC5 hop or link or connection or interface 101a. Similarly, remote UE2 102 and remote UE3 103 have PC5 hops, or links or connections or interfaces 102a and 103a respectively with the relay UE 100. A Uu hop or link or connection or interface 105a connects the relay UE 100 to the gNB 107. PC5 connections are used for the relayed traffic of the remote UEs (101, 102 and 103) and the non-relayed traffic specific to the relay UE 100 i.e. for the direct communications between relay UE 100 and the other remote UEs (101, 102 and 103). Therefore, the remote UE1 101 is connected to the gNB 107 through the relay UE 100 with a PC5 hop 101a and a Uu hop 105a: for uplink communication, the remote UE1 101 is the source node (or transmitter node for transmitting data) and the gNB 107 is the destination or target node (or receiver node for receiving data) for a sidelink relay connection established between the remote UE1 101 and the gNB 107 with a PC5 hop 101a and a second Uu hop 105a and for downlink communication, the remote UE1 101 is the destination or target node (or receiver node) and the gNB 107 is the source node (or transmitter node). Similarly, the remote UE3 103 is connected to the gNB 107 through the relay UE 100 with a PC5 hop 103a and a Uu hop 105a. The Uu link 105b connects the remote UE2 102 directly to the gNB 107. Thus, this remote UE2 102 has two distinct communication paths between the UE2 102 and the gNB 107: where the first is a direct Uu link 105b and the other path is indirect through the relay UE 100.

A connection between a remote UE, such as remote UE1 101, and the gNB 107 may be established by establishing a PC5 connection between the remote UE1 101 and the relay UE 100 with the remote UE1 101 being the initiator of the connection. A Uu connection between the relay UE 100 and the gNB 107 is established via a RRC setup (before or after the PC5 connection is established), with the relay UE 100 being the initiator of the connection. The remote UE1 101 then initiates a RRC setup with the gNB 107 through the relay UE 100 which forwards the RRC message from the remote UE1 101 to the gNB 107 for the “RRC setup request” and from the gNB to the remote UE1 101 for the “RRC setup response”.

In an example shown in FIG. 1, the UE 100 can be also a UE-to-UE relay by connecting the remote UEs 101, 102 and 103 together in a UE-to-UE (or U2U) scenario. Thus, for example, a communication path can be set up between remote UE1 101 and remote UE2 102 through the relay UE 100 connecting the PC5 hops 101a and 102a together. In UE-to-UE relay, when a sidelink relay connection is established between two remote UEs, the remote UE transmitting data (e.g. packets) is identified as the source remote UE or source UE and is connected to the relay UE by a first PC5 hop or link and the other remote UE receiving data (e.g. packets) is identified as the destination or target remote UE or destination or target UE (or receiver node) and is connected to the relay UE by a second PC5 hop or link. The source UE may be a transmitter node or transmitter transmitting packets to the destination or target UE via the relay UE and the two PC5 hops. The two direct connections (PC5 hops) between the relay UE and the two other UEs (source and target UE) for the U2U scenario are established in the same way the PC5 connection is established as discussed above for the U2N scenario. The two PC5 direct connections are established to provide a “tunneled” connection between the source and target UE through the relay UE.

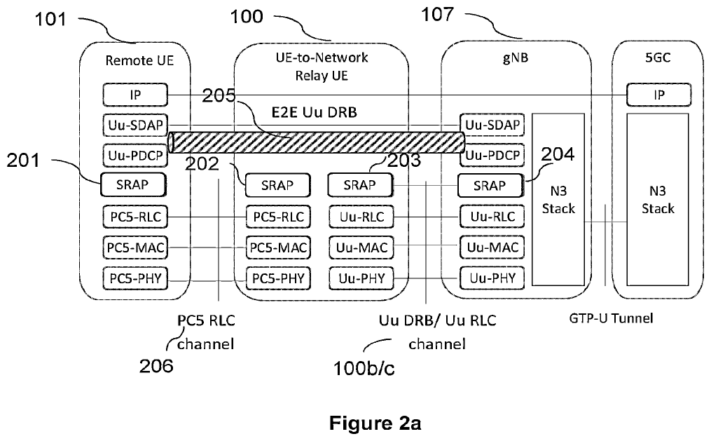

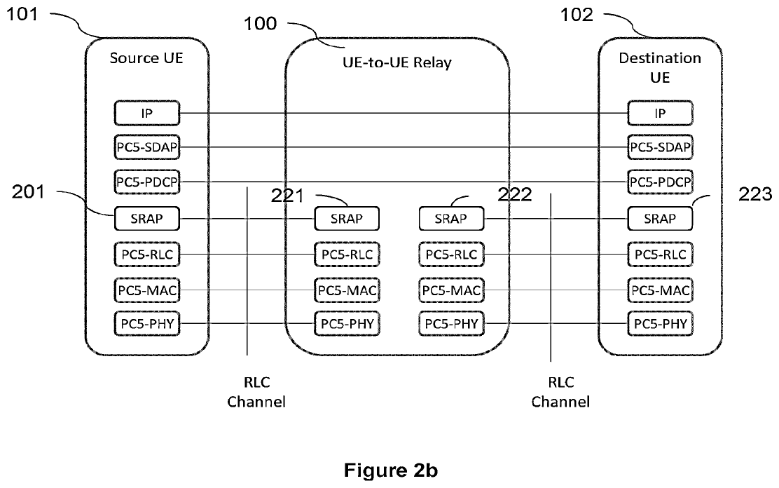

In order to set up a relayed traffic between a first node (remote UE) and a second node (gNB or remote UE), a Sidelink relay architecture may be used according to the 3GPP TR 38.836. The user plane architecture or protocol stack is shown in FIGS. 2a and 2b and represents the Sidelink Relay adaptation layer called SRAP that is introduced between the PDCP layer and the RLC layer at the extreme nodes and above the RLC layer in the relay UE.

This architecture was first documented in the TR 38.836 and finally refined in 3GPP TS 38.351. This architecture shown in FIG. 2a shows the Sidelink relay architecture for the UE-to-Network relay scenario. The architecture shown in FIG. 2b shows the Sidelink relay architecture for the UE-to-UE relay scenario. As shown in FIG. 2b, the architecture is similar to that shown in FIG. 2a. However, the relay UE in the UE-to-UE relay case has two PC5 SRAP entities or layers 221 and 222.

As shown in FIG. 2a for the UE-to-Network relay scenario, the remote UE, such as remote UE1 101, has a PC5 SRAP layer 201 between its Uu PDCP layer and it PC5 RLC layer. At the relay UE, such as relay UE 100, there are two SRAP layers to interface with the PC5 hop 101a and the Uu hop 105a: the PC5 SRAP layer 202 is connected to the PC5 SRAP 201 of the remote UE 101 through the PC5 hop 101a; and the Uu SRAP layer or entity 203 is connected to the Uu SRAP layer 204 at the gNB side 107 through the Uu link 105a. A remote UE 101 establishes End-to-End radio bearers 205 with the gNB 107. These radio bearers could be a Signalling Radio Bearer SRB or Data Radio Bearer DRB. FIG. 2a shows an E2E Uu DRB between the remote UE 101 and the gNB 107 by way of example.

The PC5 SRAP layer 202 of the UE-to-Network relay UE 100 receives data or packets (traffic data or signalling) over or via ingress PC5 RLC channels 206 from remote UE 101 in an uplink direction and transmits the packets to the Uu SRAP entity 203 of the same relay 100. The Uu SRAP 203 entity will map the corresponding ingress PC5 RLC channels 206 to egress Uu RLC channels 100b and/or 100c at Uu link 105a. Thus, a mapping table is required for uplink and it is configured by gNB 107 at the Uu SRAP entity 203 of the relay UE 100.

The mapping table takes at its input an identifier of the remote UE 101 (e.g. L2-ID), an identifier of the E2E radio bearer 205 (e.g. the E2E Uu DRB 205 ID) and an identifier of the ingress PC5 RLC channel (or bearer) 206 and identifies the egress Uu RLC bearer ID where the E2E radio bearers are mapped. For example, the UE E2E bearer ID and remote UE ID can be obtained from the header of a data packet received at the Uu SRAP entity 203. An example of an entry for an uplink mapping table with one entry configured at the Uu SRAP entity 203 is shown in Table 1 below. It will be appreciated that the mapping table will be configured so that it has an entry for each remote UE connected to the relay UE.

TABLE 1

| | | Ingress PC5 RLC | Egress Uu RLC |
|---|---|---|---|
| UE-ID | E2E Uu DRB ID | channel ID | channel ID |
| x1 | y1 | z1 | w1 |

At the Uu side or link 105a, different radio bearers of the same remote UE or different remote UEs can be subject to N:1 mapping and data multiplexing over Uu RLC channels 100b and 100c. This is discussed in more detail below.

In the downlink direction, data or packets transmitted from gNB 107 arrive at the relay UE 100 through the Uu link 105a. The ingress Uu RLC channels 100b and 100c at the Uu SRAP entity 203 of the relay UE 100 will be mapped to the egress PC5 RLC channels 206 at PC5 hop 101a. The corresponding packets in downlink will be transmitted from the Uu SRAP entity 203 to the PC5 SRAP entity 202 to be then transmitted through the PC5 RLC channels 206 to the remote UE 101. Thus, a mapping table is required for downlink and it is configured by the gNB 107 at Uu SRAP entity 203 of the relay UE 100. The mapping table requires at its input the remote UE 101 L2-ID, the End-to-End radio bearer 205 ID and the ingress Uu RLC channel (or bearer) 100b and 100c ID and delivers the egress PC5 RLC channels (or bearer) 206 ID to the PC5 SRAP entity 202 of the same relay UE 100. The End-to-End Radio bearer 205 is then mapped at the PC5 hop 101a to the egress PC5 RLC channels 206. For example, the UE E2E bearer ID and remote UE ID can be obtained from the header of a packet received at the Uu SRAP entity 203. An example of a downlink mapping table with one entry configured at the Uu SRAP entity 203 is shown in Table 2 below. It will be appreciated that the mapping table will be configured so that it has an entry for each remote UE connected to the relay UE.

TABLE 2

| | | Egress PC5 RLC | Ingress Uu RLC |
|---|---|---|---|
| UE-ID | E2E Uu DRB ID | channel ID | channel ID |
| x2 | y2 | z2 | w2 |

As mentioned in 3GPP TS 38.351, each SRAP entity has a transmitting part and a receiving part. Across the PC5 interface 101a, the transmitting part of the PC5 SRAP entity 201 at the remote UE 101 has a corresponding receiving part at PC5 SRAP entity 202 at the UE-to-Network Relay UE 100, and vice-versa. Across the Uu interface 105a, the transmitting part of the Uu SRAP entity 203 at the UE-to-Network Relay UE 100 has a corresponding receiving part at Uu SRAP entity 204 at the gNB 107, and vice-versa.

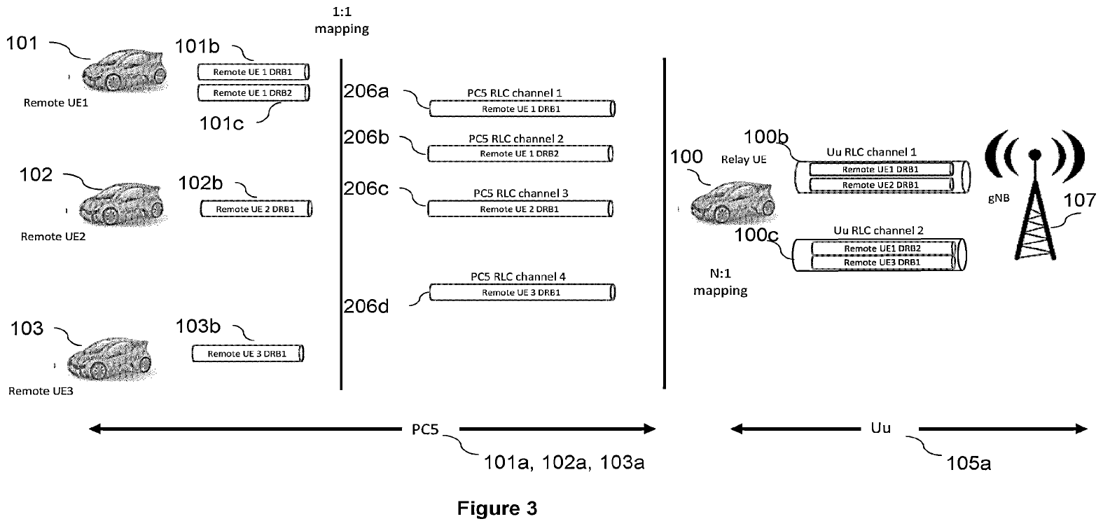

FIG. 3 shows N:1 mapping between multiple remote UEs radio bearers and the Uu RLC channels 100b, 100c at the Uu link 105a for UE-to-network Sidelink Relay. The remote UE1 101 connected through the relay UE 100 to the gNB 107 has two End-to-End radio bearers 101b and 101c that are mapped to different PC5 RLC channels 206 (respectively 206a and 206b) at PC5 hop 101a and different Uu RLC channels 100b and 100c at Uu hop 105a depending on the gNB configuration of the Uu SRAP entity 203 of the relay UE 100 (e.g. depending on the mapping tables configured at the Uu SRAP entity 203 of the relay UE 100 by the gNB 107). Similarly, the remote UE3 103 has an End-to-End radio bearer 103b established between the remote UE3 103 and the gNB 107. This E2E RB 103b is mapped to the PC5 RLC channel (206d) at PC5 hop 103a and to the Uu RLC channel 100c at Uu hop 105a depending on the mapping tables configured at the Uu SRAP entity 203 of the relay UE 100 by the gNB 107. The remote UE2 102 has one End-to-End radio bearer 102b mapped to PC5 RLC channel (206c) at PC5 hop 102a and a Uu RLC channel 100b at Uu hop 105a. As shown in FIG. 1, the remote UE2 has two distinct paths where the first Uu path 105b is direct with the gNB 107 and the second path through the relay UE 100 with two hops 102a and 105a corresponding to PC5 hop and Uu hop respectively.

As said before, the mapping tables at Uu SRAP entity 203 will map these E2E RBs to the corresponding PC5 RLC channels 206a-206d and Uu RLC channels 100b and 100c.

FIG. 3 also illustrates 1:1 mapping between radio bearers 101b, 101c, 102b, 103b and PC5 RLC channels 206a-d for the UE-to-Network relay. The E2E RBs 101b, 101c, 102b and 103b are mapped to the PC5 RLC channels 206a, 206b, 206c and 206d respectively at the PC5 interfaces 101a, 102a and 103a. At the Uu SRAP 203 of the relay UE 100, N:1 bearer mapping is supported and thus, as illustrated in the FIG. 3, the PC5 RLC channels 206a and 206c are mapped to the same Uu RLC channel 100b while the remaining PC5 RLC channels 206b and 206d are mapped to the second Uu RLC channel 100c at Uu link 105a. The N:1 mapping may exist for upstream (uplink) and downstream (downlink) packets or traffic.

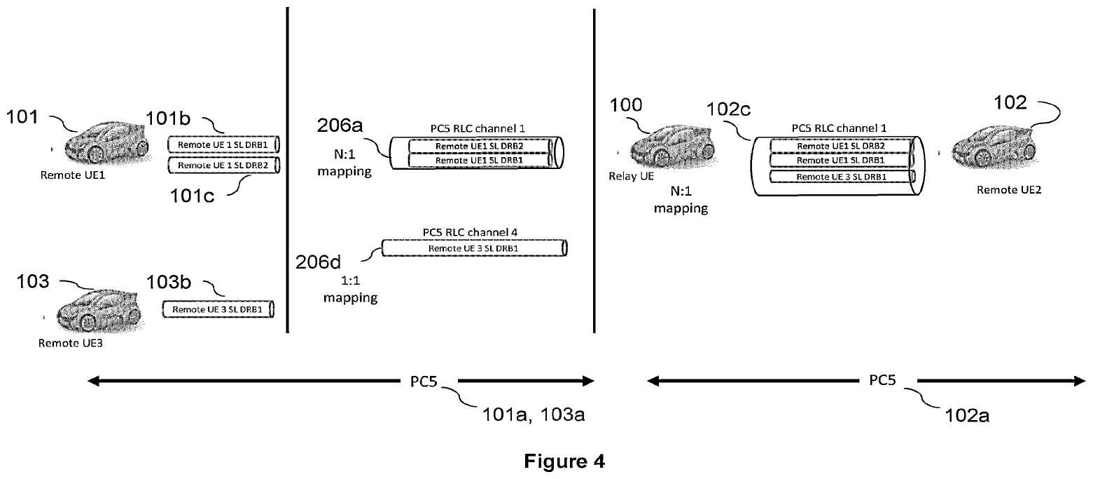

In case of UE-to-UE relay as shown in FIG. 4, the mapping will be performed at the two PC5 hops. In other words, in the example scenario of the remote UE1 101 communicating with the remote UE2 102 via the relay UE 100, the mapping will be performed at the PC5 hop 101a between the remote UE1 101 and the relay UE 100 and at the PC5 hop 102a between the relay UE 100 and the remote UE2 102. N:1 mapping is supported by the PC5 SRAP entity at the source UE (e.g. the SRAP entity 201 of remote UE1 101) for mapping between Remote UE SL Radio Bearers and the PC5 RLC channels (e.g. of the first PC5 hop 101a) for relaying as agreed in a Rel-17 Work item. For example, a source UE (e.g. remote UE1 101) may have one connection to two different destination or target UEs (e.g. remote UEs 102 and 103). In this case, N:1 mapping may be applied if the bearers of the two destinations are mapped to the same RLC channel. The PC5 SRAP entity for the second PC5 hop 102a (e.g. SRAP entity 222 of the relay 100) supports N:1 bearer mapping between multiple ingress PC5 RLC channels over a first PC5 hop and one egress PC5 RLC channel over a second PC5 hop. For example, where two source UEs (remote UEs 101 and 103) have a connection to the same destination or target UE (e.g. remote UE 102), in this case, the relay UE may apply N:1 mapping by mixing the bearer of each source UE onto the same RLC channel to reach the same destination or target UE. The second PC5 SRAP entity 222 works similarly to the Uu SRAP entity 203 in the case of UE-to-Network Relay.

For the case of UE-to-UE relay as shown in FIG. 4 and for the example scenario of the remote UE1 101 communicating with the remote UE2 102 via the relay UE 100, the SL radio bearers 101b, 101c are mapped to PC5 RLC channel 206a and thus, multiple SL radio bearers can be mapped to the same PC5 RLC channel at the first PC5 hop 101a. The second PC5 SRAP entity 222 of the relay UE 100 may map multiple ingress PC5 RLC channels over one egress PC5 RLC channel 102c at the second PC5 hop 102a. Thus, the corresponding SL radio bearers are mapped at the PC5 SRAP entities 201 and 222 of the two hops. The mapping may be performed using mapping tables in a similar manner as discussed above with respect to U2N. For example, a mapping table such as Table 3 may be used as discussed below.

TABLE 3

| | | Ingress PC5 RLC | Egress PC5 RLC |
|---|---|---|---|
| UE-ID | E2E SL DRB ID | channel ID | channel ID |
| x3 | y3 | z3 | w3 |

As discussed in the introduction, a link issue may occur on a link in the sidelink relay arrangement or system (such as the one shown and described above with reference to the FIG. 1 and the related Figures) due to various factors: such as, interference, and/or high QoS traffic, and/or propagation environment, and/or mobility of the UE. The link issue can be a congestion, a link degradation or a link failure and could occur at one or more of the PC5 hops 101a, 102a, 103a or at the Uu hop 105a. The congestion is detected by monitoring the buffer status of the relay UE 100. For example, the status of the Tx RLC buffer at the relay UE 100 can be monitored and when the amount of data in the buffer reaches a certain threshold, congestion may be detected (similar to the process for generating a Buffer Status Report (BSR) as described in TS 38.322-5.5). The link degradation is detected when the quality of the link becomes weakened (e.g. when the signal strength reaches a certain threshold) and the relay UE should inform the impacted node about the possibility of a link failure. When the link is not responding after a number of re-transmissions exceeding a threshold or a timer expiry, a link failure (e.g. Radio Link Failure (RLF) is detected.

As different types of link issues can occur such as congestion, link degradation, link failure, transient or long-term link issues, an aim of embodiments of the invention is to provide a mechanism for the relay UE node to detect a link issue and send link issue feedback information based on the detected link issue. The relay UE node may send link issue feedback information to one or more nodes impacted by the detected link issue, and/or to all of the nodes currently connected to the relay UE node and/or to one or more nodes in a coverage area of the relay UE node (e.g. in the vicinity of the relay UE node). For example, the type of link issue and the causes of the link issue can be identified such that one or more communication flows impacted by the detected link issue can be identified and the node(s) associated with the one or more communication flows impacted by the detected link issue (e.g. the impacted node(s) performing the transmission and/or reception of packets) can be informed. The communication flows may be data or control flows for relayed data or packets corresponding to one or more radio bearers and/or links: such as one or more E2E radio bearers, or one or more RLC bearers, or one or more RLC channels, or one or more PC5 links, or one or more Uu links. Thus, a communication flow impacted by the detected link issue may include a communication flow having a corresponding E2E radio bearer, or one or more RLC bearers, or one or more RLC channels, or one or more PC5 links, or one or more Uu links affected by a link issue. The relay UE node determines the impacted node(s) and informs at least one of the impacted node(s). For example, the relay UE node informs (e.g. sends link issue feedback information) impacted node(s) which are determined to be a source node (e.g. configured for data transmission) and/or informs impacted node(s) which are determined to be a destination or target node (e.g. configured for data reception). When a sidelink relay connection is established between a source node, a relay node and a destination node, a node associated with an impacted communication flow may be the source node (e.g. source UE) and/or destination (or target) node (e.g. destination or target UE) associated with the impacted communication flow (e.g. the detected link issue is associated with at least one of a first link between the source node and the relay node, and a second link between the destination node and the relay node).

The following three example scenarios where nodes impacted by the detected link issue are informed of the link issue will be considered:
1. A link issue feedback is provided as an indication to the impacted node(s));
2. A relay (re)selection feedback where the relay UE informs the link issue type occurring and triggers the remote UE for relay (re)selection while optionally the relay UE releases the PC5 link with the remote UE;
3. A link status modification feedback to inform the impacted node(s) that the corresponding link status is modified (e.g. failed or recovered).

### Link Issue Feedback:

As previously explained, the relay UE 100 monitors its internal buffer to detect a congestion. As described in the architecture figures (FIGS. 2a and 2b), the SRAP entity is located just above the RLC layer thereby, the relay UE 100 may discriminate a congestion for a specific RLC channel. Once a congestion is detected by the relay UE for one or several RLC channel(s), the relay UE 100 parses the mapping table in order to get the correspondence to the impacted E2E bearer(s), ingress RLC channel(s) and the impacted node(s) to create the link issue feedback (e.g. to identify one or more communication flows impacted by the detected link issue).

In an example of a congestion occurring in a case of downlink communication (UE-to-Network (U2N) relay scenario) i.e. the transmitter or source node is the gNB 107 as illustrated in the FIG. 3, the relay UE 100 detects a congestion at the PC5 RLC channel 206a. The relay UE 100 based on the mapping table at Uu SRAP layer 202 (see Table 2 for downlink as discussed above) determines that the ID of the corresponding ingress Uu RLC channel 100b which is mapped to the egress PC5 RLC channel 206a and the ID of the E2E Radio Bearer corresponding to the remote UE 1 DRB1 101b of the remote UE1 101 are impacted by the congestion link issue (e.g. the remote UE 1 DRB1 101b and Uu RLC channel 100b are communication flows or paths impacted by the link issue relating to congestion at the PC5 RLC channel 206a). The relay UE 100 creates or generates the congestion link issue feedback (e.g. link issue feedback information) including the Uu RLC channel ID and the E2E Radio Bearer ID (e.g. for identifying one or more communication flows or paths impacted by the link issue). As the transmitter (gNB 107) is impacted by the congestion link issue, the link issue feedback is sent by the relay UE 100 to the gNB. In this example, due to the 1:1 mapping between E2E radio bearer and the congested PC5 RLC channel 206a, the congestion occurs only at a single E2E Radio Bearer (DRB1 of the remote UE1) 101b and thus the QoS flow ensured in this Radio Bearer will be congested.

In an example of a congestion occurring in a case of uplink communication (UE-to-Network relay scenario) i.e. the remote UEs 101, 102 and 103 are the transmitters (e.g. a source node or a transmitter node transmitting packets to the relay UE 100 for relaying to gNB 107) as illustrated in the FIG. 3, the relay UE 100 detects a congestion at the Uu RLC channel 100b. In that example, multiple E2E Radio Bearers (such as 101b and 102b) and corresponding ingress PC5 RLC channels (such as PC5 RLC channels 206a and 206c) are mapped to the same congested egress Uu RLC channel 100b (e.g. the remote UE 1 DRB1 101b and the remote UE 2 DRB1 and PC5 RLC channels 206a and 206c are communication flows or paths impacted by the link issue relating to congestion at the Uu RLC channel 100b). Then, the relay UE 100 based on the mapping table at Uu SRAP layer 203 (see Table 1 for uplink as discussed above) determines that the ID of the corresponding ingress PC5 RLC channels 206a and the PC5 RLC channels 206c which are mapped to the egress Uu RLC channel 100b and the ID of the E2E Radio Bearers corresponding to the remote UE1 DRB1 101b of the remote UE1 101 (encapsulated in the PC5 RLC channel 1 206a) and to the remote UE2 DRB1 102b of the remote UE2 102 (encapsulated in the PC5 RLC channel 3 206c) are impacted by the congestion link issue. The relay UE 100 creates the congestion link issue feedback (e.g. link issue feedback information) including the PC5 RLC channel ID and the E2E Radio Bearer ID (e.g. for identifying one or more communication flows or paths impacted by the link issue). As the relay UE 100 determines that several nodes (UE1 101 and UE2 102) are impacted by the congestion link issue, the link issue feedback is sent by the relay UE 100 to these impacted nodes. To reach the impacted nodes, the relay UE 100 may send the congestion link issue feedback in broadcast or in multicast or in groupcast if an address of a group including these impacted nodes exists (the group creation is out of the scope of this specification). Alternatively, the relay UE 100 may send the congestion link issue feedback individually (in unicast) to each impacted node. In another alternative, the relay UE 100 may create one congestion link issue feedback dedicated to each impacted node i.e. including only information relative to the impacted node instead of the information relative to all impacted nodes and send this dedicated congestion link issue feedback in unicast to the impacted node.

In an example of a congestion occurring in a UE-to-UE (U2U) relay case for communications from UE1 101 to UE2 102 and from UE3 103 to UE2 102, each one relayed by the relay UE 100 as illustrated in the FIG. 4, the relay UE 100 detects a congestion at the PC5 RLC channel 102c. The relay UE 100 based on the mapping table at PC5 SRAP layer 222 (see Table 3 for U2U case as discussed above) determines that the ID of the corresponding ingress PC5 RLC channels 206a and 206d which are mapped to the egress PC5 RLC channel 102c and the ID of the E2E Radio Bearers corresponding to the Sidelink Data Radio Bearer 1 (SL DRB1) and SL DRB2 of the remote UE1 (respectively 101b and 101c) encapsulated in the PC5 RLC channel 1 206a and to the SL DRB1 103b of the remote UE3 103 encapsulated in the PC5 RLC channel 4 206d are impacted by the congestion link issue (e.g. the remote UE 1 SL DRB1 101b, the remote UE 1 SL DRB2 101c, and the remote UE 3 SL DRB1 103b and PC5 RLC channels 206a and 206d are communication flows or paths impacted by the link issue relating to congestion at the PC5 RLC channel 102c). The relay UE 100 creates the congestion link issue feedback (e.g. link issue feedback information) including the PC5 RLC channel ID and the E2E Radio Bearer ID (e.g. for identifying one or more communication flows or paths impacted by the link issue). As the relay UE 100 determines that several nodes (UE1 101 and UE3 103—which are source nodes in this case) are impacted by the congestion link issue, the link issue feedback is sent by the relay UE 100 to these impacted nodes. To reach the impacted nodes, the relay UE 100 may send the congestion link issue feedback in broadcast or in groupcast if an address of a group including these impacted nodes exists (the group creation is out of the scope of this specification). Alternatively, the relay UE 100 may send the congestion link issue feedback individually (in unicast) to each impacted node. In another alternative, the relay UE 100 may create one congestion link issue feedback dedicated to each impacted node i.e. including only information relative to the impacted node instead of the information relative to all impacted nodes and send this dedicated congestion link issue feedback in unicast to the impacted node.

In an example of a congestion occurring in a UE-to-UE relay case for communications from UE2 102 to UE1 101 and from UE2 102 to UE3 103, each one relayed by the relay UE 100 as illustrated in the FIG. 4, the relay UE 100 detects a congestion at the PC5 RLC channel 206d. The relay UE 100 based on the mapping table at PC5 SRAP layer 222 (see Table 3 for U2U case as discussed above) determines that the ID of the corresponding ingress PC5 RLC channels 102c which is mapped to the egress PC5 RLC channel 206d and the ID of the E2E Radio Bearers corresponding to the SL DRB1 103b of the remote UE3 103 encapsulated in the PC5 RLC channel 4 206d are impacted by the congestion link issue (e.g. the remote UE 3 SL DRB1 103b and PC5 RLC channel 102c are communication flows or paths impacted by the link issue relating to congestion at the PC5 RLC channel 206d). The relay UE 100 creates the congestion link issue feedback (e.g. link issue feedback information) including the PC5 RLC channel ID and the E2E Radio Bearer ID (e.g. for identifying one or more communication flows or paths impacted by the link issue). As the relay UE 100 determines that the UE2 102 is impacted by the congestion link issue, the relay UE 100 sends the link issue feedback to this impacted node (which is a source node in this case). To reach the impacted node, the relay UE 100 may send the congestion link issue feedback in broadcast, in groupcast or in unicast as discussed above.

When the relay UE 100 sends the congestion link issue feedback in broadcast, the congestion link issue feedback may be received by all UEs in the vicinity of the relay UE 100 and may inform all UEs that the relay UE has some trouble to reach one UE. This information may be useful as a criteria of relay selection.

In an example, when a relay UE node detects a link issue in the wireless communication system (e.g. as shown in FIG. 1), in response to detecting the link issue, the relay UE node generates link issue feedback information for the detected link issue including information for identifying a type of the detected link issue and sends the link issue feedback information in a discovery message. In another example, when a relay UE node detects a link issue in the wireless communication system (e.g. as shown in FIG. 1), in response to detecting the link issue, the relay UE node may stop sending one or more discovery messages: i.e. the relay UE node may change (e.g. stop) the discovery process performed at the relay UE node so as to stop sending any announcement message (for discovery model A as defined in 3GPP TS 23.303 for LTE or TS 23.304 for 5G system, V17.1.1) or any response message (for discovery model B as defined in 3GPP TS 23.303 for LTE or TS 23.304 for 5G system, V17.1.1). By stopping sending the discovery messages, the UEs in the vicinity of the relay UE node (e.g. relay UE 100) will not receive information from the relay UE node and so will therefore not consider the relay UE when performing relay (re)selection. For example, when a remote UE acting as a discoverer UE sends a discovery solicitation message for discovering a relay UE node (e.g. in response to a trigger event), in a case where the relay UE node has stopped sending any discovery messages the remote UE will not receive a response message. In response to not receiving a message in response to the discovery solicitation message, the remote UE then performs an action. The remote UE may start a timer on sending the discovery solicitation message and may perform an action if no response message is received within a certain time period as determined by the timer. The discovery solicitation message may be sent by broadcast, unicast or groupcast. The action may include performing (re)selection or a discovery process for a different relay UE node or determining that there is no relay available (e.g. currently) in the vicinity of the remote UE node. Different types of link issue may include: congestion, or link degradation, or Radio Link Failure, RLF, or short-term/transient or long-term link issues. The discovery message may be broadcast by the relay UE autonomously in a regular manner for discovery model A or may be a discovery message sent back by the relay UE in response to a request from a discoverer UE that intend to associate to a relay UE (as defined in the TS 23.303 or/and TS 23.304). In the latter case, the discoverer UE may indicate in its discovery request message its interest to have a status of the requested relay UE(s) for instance concerning the link(s) or the connectivity with the other UEs. The discovery message may be received by UEs in the vicinity or coverage area of the relay UE. The information for identifying the type of link issue may include an identifier for identifying the type of link issue. The information may also include reason/context information for indicating a reason for or context of the detected link issue. The identifier may be a reason ID as discussed below which may just indicate the type of link issue or may indicate both the link issue type and a reason for or context of the link issue as discussed below (see also Tables 4 and 5 as examples of reason IDs).

The aforementioned examples assume that the congestion is detected at the egress RLC channel(s) for instance by monitoring the amount of data in Tx RLC buffer. In an alternative embodiment, the monitoring may be performed at the RX RLC buffer in the relay UE and then the congestion will be detected at the ingress RLC channel(s) and the relay UE then skips the step of mapping from egress RLC channel to ingress RLC channel as described in the above examples. In another alternative, the relay UE may use a Channel Busy Ratio (CBR) and/or Channel occupancy Ratio (CR) metrics (as defined in the TS38.215) to infer a congestion and then create the congestion link issue feedback. In such cases, the link issue feedback information may be sent by broadcast (in which case the relay UE may not need to identify the impacted nodes). Alternatively, a CBR/CR report may be provided to the relay UE by different nodes and from the CBR/CR report, the relay can identify which are the impacted nodes to which the link issue feedback information is to be sent. In another example, the relay UE may perform itself the CBR/CR measurement and from the measurements, the relay UE can identify on which resource pool (e.g. frequency band), the link issue occurs. As the relay UE knows on which frequency the PC5 link is established for each remote UE, the relay can infer the identity of the impacted nodes based on the resource pool or frequency experiencing an issue. In case an excessive CBR or CR is detected over a given link, this link may be considered as experiencing a link issue. It would then be treated in the same way as an RLF is treated.

In an additional example, the relay UE may detect the congestion at a particular E2E Radio Bearer by monitoring the amount of data associated to each E2E Radio Bearer by inspecting the SRAP header of each packet at the SRAP layer to get the Bearer Id of the packet and so determine the amount of data ratio of each E2E radio bearer in a RLC channel. The relay UE may detect congestion at a E2E radio bearer when the relay UE determines the data ratio of the E2E radio bearer for the RLC channel is too high.

In case of downlink in U2N relay between a gNB and a remote UE, the remote UE could be notified with the link issue occurring at PC5 hop or Uu hop or at E2E Radio Bearer by the relay UE sending to the remote UE (as a receiver node) link issue feedback information for the link issue and for identifying the communication flows impacted by the detected link issue even though it is not a source node (e.g. a transmitter node for transmitting packets to the relay UE 100 for relaying to another node). In other words, the relay UE may send the link issue feedback information for the detected link issue to a source node and/or a destination node. A remote UE configured as a destination node will not wait then for packets from gNB and will not ask for re-transmission until the link recovery.

In case of U2U relay, the link issue feedback may be sent to the source UE and/or the destination remote UE to notify of link issues in reception.

In other words, for U2N and/or U2U relay, the relay UE may send link issue feedback information to a source node and/or a destination node of a sidelink relay connection impacted by a link issue. The relay UE may send link issue feedback information to one or more other nodes connected to the relay UE. In another example, the relay UE may send link issue feedback information to all UEs (e.g. UEs not yet connected to a relay or connected to another relay) in the vicinity or coverage area of the relay UE 100 via broadcast.

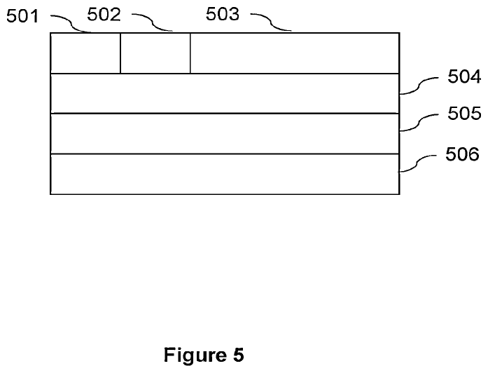

The congestion could occur at link level whether at PC5 hop or Uu hop and thus, the source node or transmitter (and as discussed above, may be also the destination node or the receiver) may be notified by the relay UE of link issues according to the following different example scenarios:
If the congestion occurs at PC5 hop 101a—
   The transmitter or source node is the remote UE1 101: the link issue feedback information is sent by the relay UE 100 to the remote UE1 101 and includes (e.g. in its Information Elements as discussed below with reference to FIG. 5) the L2-ID of the remote UE1 101. Thus, the remote UE1 101 based on the link issue feedback information understands that the congestion occurs at the entire PC5 hop 101a. The E2E Radio bearers 101b & 101c ID are included in the link issue feedback information in order to identify which radio bearers are impacted in case of multiple PC5 links between the remote UE1 101 and the relay UE 100.
   The transmitter or source node is the gNB 107 in case of U2N relay (or remote UE (e.g. UE2 102) in case of U2U relay). The link issue feedback information is sent by the relay UE 100 to the source node (optional for the destination node or receiver) with the L2-ID of the remote UE1 101 attached to the PC5 hop 101a. The E2E Radio bearers 101b & 101c ID are also specified to the gNB 107 by Uu SRAP entity 203 in order to identify which Radio bearers are impacted at PC5 hop 101a in case of U2N relay. In case of U2U relay, the link issue feedback is sent to the source node (e.g. source remote UE2 102) (and optionally may also be sent to the destination node or receiver e.g. destination remote UE UE1 101) with the L2-ID of the source remote UE and the SL Radio bearers ID that are impacted. The PC5 SRAP entities of the relay UE provide the SL Radio bearers ID that are mapped to the PC5 RLC channels as discussed above.
In other words, if an issue occurs on a PC5 link, the link impacted by the issue will be identified by the L2-ID of the remote UE connected to this relay UE.
If the congestion occurs at Uu hop 105a in case of U2N relay—
   The transmitter or source node is the remote UE1 101. The link issue feedback information is sent by the relay UE 100 to the source node specifying for instance the L2-ID of the relay UE 100 as an identification of the Uu link. In another embodiment, a link issue without any L2-ID value or default value would indicate an issue on the Uu link. The remote UE1 101 will understand that the congestion occurs at the Uu link 105a (U2N relay). The overall E2E Radio Bearers are congested at Uu hop 105a (U2N relay). And thus, in case of U2N relay, the Uu SRAP entity 203 specifies the E2E Radio Bearers ID 101b & 101c of the remote UE1 101 that are impacted in the link issue feedback.
   The transmitter or source node is the gNB 107 for U2N relay. The link issue feedback information sent to the source node (optionally to the destination node or receiver) specifies for instance the L2-ID of the relay UE 100 (as an identification of the Uu link) and the list of Radio bearers (101b, 101c, 102b and 103b) that are impacted by the link congestion.

In the examples above, the identification of the link experiencing an issue with the usage of the L2-ID (which is normally used to identify a UE) replaces, in a more compact manner, the indication of the impacted RLC channel(s) in the congestion link issue feedback. The node receiving the congestion link issue feedback then determines its impacted RLC channel(s). For instance, if an issue occurs on the Uu link, the link impacted by the issue can be identified by the L2-ID of the relay UE or in another example, a link issue without any L2-ID value or default value would indicate an issue on the Uu link. In another case, if an issue occurs on a PC5 link, the link impacted by the issue can be identified by the L2-ID of the remote UE connected to this link. In another example, the identification of the link experiencing an issue (i.e. using a Link identifier, ID, information element) may replace the list of the impacted radio bearer(s) and/or the list of the impacted RLC channel(s).

A link degradation, which is the step before a link failure, announces to the impacted node(s) the possibility of a link failure. It could occur at PC5 hop or Uu hop and can impact the traffic at this hop for large amount of data. In other words, the link issue feedback sent by the relay UE in this particular scenario would indicate to the impacted nodes link degradation with the possibility of link failure.

A link failure comes after a link degradation. In one embodiment of the invention, a link failure is detected when the link quality (e.g. SNR or RSRP) falls down below a critical threshold level. In another embodiment, a link failure is detected when a link degradation could not be recovered (e.g. a link degradation was detected on a given link for a predefined time period). In another embodiment, the link failure is detected by timer expiration and/or counter threshold. For instance, as defined in the TS38.331, the usage of the counter N310 indicating the number of “out-of-sync” received from the physical layer in addition to the timer T310 may trigger a radio link failure. The information to be included in the link issue feedback for signalling a link failure or a link degradation (e.g. for identifying one or more communication flows or paths impacted by the link issue) is discussed below with reference to FIG. 5.

Meanwhile, a link issue feedback for a link degradation (including a link failure), in U2N relay is sent by the relay UE only to the remote UE in uplink (e.g. the source or transmitter node) when Uu link degradation occurs. For U2U relay, the link issue feedback is sent by the relay UE to a remote UE when the other remote UE suffers from link quality degradation: e.g., when a link degradation occurs at the second PC5 hop between the relay UE and the other remote UE operating/acting as a destination or target UE, the second hop between the relay and the destination UE is hidden from the remote UE operating/acting as a source remote UE (connected to the relay UE over a first PC5 hop), and so the source UE will be notified with a link issue feedback reporting the link quality degradation of the second PC5 hop. With reference to FIG. 1, as an example remote UE1 101 is designated the source remote UE (or source UE) connected to the relay UE 100 by a first PC5 hop 101a and is in communication with a remote UE2 102 designated as the destination or target remote UE (or target UE). Target UE2 102 is connected to the relay UE 100 by a second PC5 hop 102a. When the source UE1 101 is transmitting packets to the target UE2 102, the second PC5 hop 102a is ‘hidden’ from the source UE1 101 and then when there is link quality degradation on the second PC5 hop 102a, the source UE1 101 is sent the link issue feedback information by the relay UE 100.

To differentiate between the different link issues, in an example and as discussed with reference to FIG. 5, the link issue feedback information may further include information for identifying a type of the detected link issue (e.g. whether the link issue is one of the following types of link issue: congestion, or link degradation, or RLF, or transient/short-term or long-term). The information may include a reason identifier (ID) for identifying the type of the detected link issue. In an example, the reason ID may in addition to identifying the type of the detected link issue may also represent a reason for or context of the detected link issue. For example, the reason ID may identify that the link issue is one of the following types of link issue: congestion on a PC5 hop, congestion on a Uu hop, congestion on an E2E Uu RB, congestion on a remote UE E2E RB, congestion on a Uu RLC channel/bearer, congestion on a PC5 RLC channel/bearer, link degradation, link level congestion (on PC5 hop or Uu hop), RLF. In an example arrangement, the reason ID is included in a link issue signalling message specifying the type of the announced link issue at the corresponding hop. The reason identifier may be a number or other identifier to distinguish between different types of and/or reasons for the link issue. For example, a reason ID equal to 1 mentions a Radio bearer congestion while a reason ID equal to 5 indicates an RLC channel congestion at PC5 hop. In order to provide further information concerning the link issue, when the reason ID equals 1, this may indicate a radio bearer congestion for the reason a new QoS has been added to the E2E DRB. For other examples of reason IDs, see Tables 4 and 5 below. In another example, the information for identifying a type of the detected link issue may include a link issue type identifier (e.g. PDU type identifier) that identifies a type of the detected link issue (e.g. whether the link issue is one of the following types of link issue: congestion, or link degradation, or RLF, or transient or long-term (e.g. permanent) or event). In this case, the link issue feedback information may also include a reason identifier (ID) which indicates a reason for or context of the detected link issue as discussed above. Additional information can be included (for example, see the discussion below with reference to FIG. 5 regarding additional Information Elements) in order to inform the impacted node(s) properly about the link issue with a better visibility of the situation at relay UE and the impacted node(s).

The link issue feedback information may be sent in a link issue signalling message for signalling or indicating a link issue.

### Relay (Re)Selection Feedback:

A relay UE (100) may decide to send a relay (re)selection trigger or relay (re)selection signalling to a remote UE (101, 102, 103) connected to the relay UE (or one or more or all of the remote UEs connected to the relay UE if there are more than one remote UE connected to the relay UE) after detecting a link issue. The sending of a relay (re)selection signaling aims to direct the remote UE to switch to another relay UE. For instance, if the relay UE detects a congestion at a low priority QoS RLC channel caused by some large amount of data to transmit at a high priority QoS, the relay UE may consider that the remote UEs impacted by the congestion should move to another relay UE. In this example, the relay (re)selection signalling message includes information (e.g. a reason ID) corresponding to congestion or congestion on low priority flow. In another example, if the relay UE detects a link failure at the Uu hop (between the relay UE 100 and the gNB 107), the relay UE may send a relay (re)selection signaling message including a reason ID relative to link failure. Thus, the reason ID may specify the link issue type (e.g. whether the link issue is one of the following types of link issue: congestion, or link degradation, or RLF) and/or the context of or reasons for the link issue. The reason ID information may be split into two parts: a main part including the type of link issue or more generally the event triggering the relay (re)selection (e.g. radio link failure, Uu radio link failure, PC5 radio link failure, congestion, relay handover, internal issue (such as, low battery, CPU usage, user change, relay capability disabled), or other event) and an optional part for additional context information. This additional information may indicate whether the issue is considered as permanent (long-term) or transient (short-term). In case the reason ID indicates a radio link failure, this additional information may indicate the nature of the link that is impacted, i.e. Uu link or PC5 link. The split of the reason ID may make the relay (re)selection signaling message more compact and let the relay UE add extra information if it is necessary. Examples of reason ID are given in the below tables:

TABLE 4

| Reason ID | Description |
|---|---|
| 0 | Radio Link Failure |
| 1 | Congestion |
| 2 | Handover |
| 3 | Internal issue |

TABLE 5

| Extended Reason ID | Description |
|---|---|
| 0 | Low priority for QoS served |
| 1 | New QoS flow |
| 2 | Mobility |
| 3 | Low battery |
| 4 | CPU usage |
| 5 | User change |
| 6 | Relay capability disabled |
| 7 | SNR degradation |

The reason ID in tables above are presented for the sake of illustration. As formerly explained, the reason ID may be grouped into a single range of ID instead of two ranges of reason ID.

In the example above, the remote UE(s) receiving the relay (re) selection signaling is/are responsible to release the connection with the relay UE in order to execute a relay (re)selection. In some cases, the remote UE would prefer to keep the connection with its current relay UE because no other relay UE candidate is available in its near proximity or the remote UE keeps the connection with the relay as a backup path and reroutes the data on another path (e.g. direct connection with a gNB).

In another example, the relay UE may decide to release the remote UE connected to the relay UE (or one or more or all of the remote UEs connected to the relay UE if there are more than one remote UE connected to the relay UE) after detecting a link issue. Thus, when the relay UE decides to release a remote UE, the relay UE sends link issue feedback information including flow information for identifying one or more communication flows and information indicating the link issue feedback information relates to relay (re)selection feedback to the remote UE. The link issue feedback information may be sent in a link issue signalling message configured to indicate relay (re)selection. The link issue signalling message for indicating relay (re)selection feedback specifies the link issue type in the reason ID and asks or requests for a release of the PC5 link with its remote UE and trigger a relay (re)selection. As an example, if a link congestion occurs at the Uu hop 105a for a sidelink relay connection between remote UE1 101 and gNB 107, whether in uplink or downlink traffic, the relay UE 100 may estimate that it is better to release its remote UE (remote UE1 101) in order that the released remote UE can (re)select another relay UE that doesn't experience a link issue. This step may help the relay UE to alleviate the link issue at its side.

The link issue signalling message for signalling relay (re)selection or the relay (re) selection message may include all or part of the information elements described in FIG. 5. For example, the link issue signalling message for indicating relay (re)selection may include link issue feedback information including information for identifying a type of the detected link issue (e.g. different types of link issue including: handover, congestion, link degradation, Radio Link Failure, RLF). The information for identifying a type of the detected link issue may include a reason identifier or another identifier for identifying a type of the detected link issue. The information may also include reason/context information for indicating a reason for or context of the detected link issue. The reason ID may, in addition to identifying the type of link issue, may also indicate a reason for or context of the detected link issue as discussed above.

In an example, when a relay UE node detects a congestion link issue in the wireless communication system (e.g. as shown in FIG. 1), in response to detecting the congestion link issue, the relay UE node generates link issue feedback information including information for indicating a congestion link issue has been detected and sends the link issue feedback information in relay (re)selection signalling or a relay (re)selection message. The relay (re)selection signalling may be sent to remote UEs impacted by the congestion link issue or to all of the remote UEs connected to the relay UE. The information for indicating the congestion link issue may include an identifier identifying a congestion type of link issue and may also include reason/context information for indicating a reason for or context of the congestion. The identifier may be a reason ID as discussed above which may just indicate the congestion type or may indicate both the congestion type and a reason for or context of the congestion as discussed above (see also Tables 4 and 5 for examples of congestion reason IDs).

In another example, the link issue signalling message for indicating relay (re)selection may include link issue feedback information including link issue flow information for identifying one or more communication flows impacted by the detected link issue (e.g. flow identifiers for the impacted radio bearer(s) and radio link(s)) as discussed above with respect to the link issue feedback

### Link Status Modification Feedback:

On detecting a link issue, the relay UE 100 may determine whether the link issue is a transient/short-term link issue (e.g. the link has been or will shortly be recovered) or whether it is a long-term link issue (e.g. a link issue which gets worse and which results in not being able to recover the link issue (i.e. a permanent link issue)). For example, the relay UE sets a timer or starts a counter and determines whether the link is recovered (e.g. responding) or not. If the link is not responding after a number of re-transmissions exceeding a timer expiry or a counter threshold, a link failure (e.g. Radio Link Failure (RLF)) is detected. When the relay UE determines that the link has been recovered or cannot be recovered, the relay UE sends (e.g. to the impacted nodes) link issue feedback information including flow information for identifying one or more communication flows impacted by the detected link issue and may further include information for identifying a type of the detected link issue (e.g. link degradation, RLF . . . ) and may also include information indicating the link issue feedback information relates to link status modification feedback information. The link status modification feedback information may announce a link recovery or link issue that gets worse.

The link status modification feedback message may include all or part of the information elements described in FIG. 5. For example, the link issue signalling message for indicating link status modification feedback includes the link issue feedback information including flow information for identifying one or more communication flows impacted by the detected link issue (e.g. flow identifiers for the impacted radio bearer(s) and radio link(s) as discussed above with respect to the link issue feedback scenario).

FIG. 5 illustrates an example format of a link issue signalling message in accordance with embodiments of the invention.

As discussed above, the link issue signalling message, which is sent to at least one of the impacted nodes (and which may be for signalling any one of link issue feedback, relay (re)selection feedback or link status modification feedback), includes link issue feedback information for the detected link issue. In an example, the link issue feedback information includes flow information for identifying one or more communication flows impacted by the detected link issue. Thus, the link issue signalling message sent to impacted node(s) may include Information Elements for providing the link issue feedback information for identifying one or more communication flows impacted by the detected link issue. Additional Information Elements are added optionally to provide better visibility (e.g. more details) of the link issue. Some of the additional Information Elements may depend on the information provided in other Information Elements.

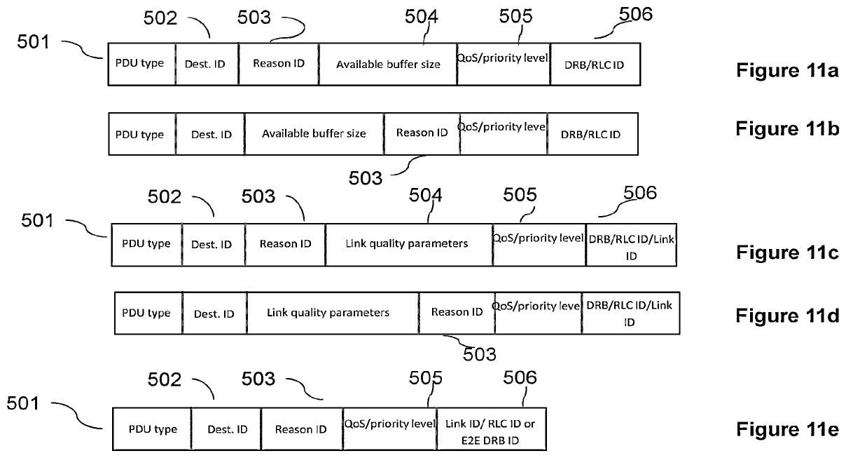

The link issue signalling message may be composed from six Information Elements, IEs, as specified in the FIG. 5. The order of the IEs shown in FIG. 5 is for illustrative purposes only. For example, the position of IEs 503 and 504 may be interchanged as shown in FIGS. 11a and 11b and in 11c and 11d.

Information Element 501 is a PDU type Information Element and information provided in this Information Element 501 specifies or indicates the type of the feedback sent to the impacted node(s) in the link issue signalling message. The PDU type of feedback could be a link issue feedback, a relay (re)selection feedback or a link status modification feedback as discussed above. The type of the link issue signalling message helps to indicate to a node receiving the link issue signalling message one or more actions to be taken. In another example, the PDU type Information element 501 may include information for identifying an event or a type of the detected link issue (e.g. whether the link issue is one of the following types of link issue: congestion, or link degradation, or RLF, or transient or long-term). For example, PDU type IE 501 may include a number as indicated in Table 4 above representing one of the different types of link issues or event.

A link issue feedback type of a link issue signalling message provides an indication to the impacted node(s) about the link issue and identifies the impacted communication flows (e.g. the impacted bearers or links or channels) and may also provide an indication about the link issue type (e.g. congestion, link degradation, RLF). The link issue feedback type may also provide an indication of the reason for or context of the detected link issue. A relay (re)selection feedback type of a link issue signalling message provides an indication to the impacted node(s) of a relay (re)selection feedback for triggering the remote UE after a release of the PC5 link with the relay UE to (re)select another UE as a relay UE. The link issue signalling message for relay (re)selection may indicate a type of the detected link issue (e.g. congestion when a congestion link issue is detected) and may also provide an indication of the reason for or context of the detected link issue. In this case, flow information identifying the impacted communication flows may be optionally provided in the signalling message. In another example, the link issue signalling message for relay (re)selection feedback type identifies the impacted communication flows (e.g. the impacted bearers or links) and may also specify the link issue type (e.g. congestion, link degradation, RLF) causing the relay (re)selection. A link status modification feedback type of a link issue signalling message provides an indication to the impacted node(s) of signalling link status modification feedback so as to notify the impacted node(s) of any modification occurring at the link issue: for example, the link issue signalling message may, in addition to identifying the impacted communication flows, provide information indicating the link issue has been or is being alleviated (or recovered) or is more intensified (or got worse). The link status modification feedback may be sent by the relay UE after the relay UE has previously sent a link issue feedback type of a link issue signalling message to the impacted node(s).

The Information Element 502 specifies the destination ID of the link issue signalling message. Information Element 502 will therefore include an identifier (such as L2 ID) of the impacted node(s). For example, considering a link failure at the Uu hop 105a for uplink traffic, the destination of the link issue signalling message is the transmitter remote UE1 101 and its ID will be included in the Information Element 502. In the case where there are more than one impacted nodes and one link issue signalling message is to be sent per impacted node (e.g. by unicast communication), IE 502 will include a single node identifier of the respective impacted node. In the case where there are more than one impacted nodes and one link issue signalling message is to be sent to all of the impacted nodes, IE 502 carries a list of the node identifiers of all of the impacted nodes (e.g. for broadcast communication) or a group identifier (e.g. for groupcast communication). This information in IE 502 may be optional if it is added by another layer during encapsulation process. For instance, destination L2_ID is present in the MAC subheader for the SideLink Shared CHannel (SL-SCH) in the DST field as described in the TS38.321 section 6.2.4.

When IE 501 indicates the type of the feedback sent to the impacted node(s) in the link issue signalling message, the Information Element 503 identifies a type of the detected link issue and may include an identifier for identifying the type of link issue. The Information Element 503 may also indicate a reason for or a context of the detected link issue. The identifier may be a reason ID as discussed above which may just indicate the type of link issue or may indicate both the link issue type and a reason for or context of the link issue as discussed above (see also Tables 4 and 5 for examples of reason IDs). The reason ID may be a number or other identifier to distinguish between different types of link issue and/or reasons for the link issue. For example, the reason ID may identify that the link issue is one of the following types of link issue: congestion on a PC5 hop, congestion on a Uu hop, congestion on an E2E Uu RB, congestion on a remote UE E2E RB, congestion on a Uu RLC channel/bearer, congestion on a PC5 RLC channel/bearer, link degradation, link level congestion (on PC5 hop or Uu hop), RLF. The reason ID may provide additional information concerning the reason for the link issue as described above. The reason ID may also embed information related to the short-term or long-term (i.e. a link issue lasting longer than a predefined timing threshold) nature of a link issue.

In an alternative, as discussed above the PDU type Information Element 501 may indicate the type of issue (congestion, link failure . . . ) and the Information Element 503 in this case further indicates the reason of the detected link issue: new QoS flows, low priority for QoS served, SNR degradation, etc. For example, the Information Element 503 includes a reason ID for indicating a reason for or context of the link issue as discussed above (see also Tables 4 and 5 for examples of reason IDs).

The presence and the signification of the Information Element 504 depends on the content of the PDU type Information Element 501 and/or the content of the Reason ID Information Element 503. The Information Element 504 may include information resulting from the link issue detection, such as available buffer size when the link issue type is congestion which is detected based on the available buffer status or may include link quality parameters (e.g. RSRP, RSRQ, SINR) when the link issue type is link degradation which is detected based on the link quality parameters. For instance, if the reason ID mentioned in the Information Element 503 is related to a radio bearer congestion, the Information Element 504 will specify the available buffer size. See for example, FIG. 11a to FIG. 11e: FIG. 11a and FIG. 11b show Information Elements of example link issue signalling messages for a congestion type of link issue; FIG. 11c and FIG. 11d show Information Elements of example link issue signalling messages for a link degradation type of link issue and FIG. 11e shows Information Elements of an example link issue signalling message for a link level congestion and RLF type of link issue.

The available buffer size or the link quality parameters optionally provided in the Information Element 504 can be alternatively replaced by other information which provides an indication as to the magnitude or level of the link issue such as a criticality level. For example, the other information may indicate a criticality level which gives the impacted node(s) an explicit view of the buffer status at the relay UE: i.e., the buffer size criticality can be categorized into low, medium or critical according to buffer size threshold. The link quality parameters can be classified into medium, weak and critical according to the link quality parameters that are assessed. One or more of three parameters can be used to evaluate the link quality parameters such as RSRP (Reference Signal Receive Power), RSRQ (Reference Signal Receive Quality) or SINR (Signal Interference and Noise Ratio).

Information indicating a QoS or the priority level ensured in the impacted bearer/channel in comparison to the QoS or priority of the other bearer/channel(s) served by the relay UE can also be introduced into the link issue signalling message and helps the impacted node(s) to take decisions accordingly to the ensured service in the bearer/channel: e.g., if a higher QoS than the QoS of the impacted bearer or channel is served by the relay UE, the impacted node(s) may wisely release the established connection or try to reconfigure the bearer impacted by link issue problems. This Information Element may for instance include a list of the QoS/priority level of the RLC channel served by the relay. This information may be carried by Information Element 505 and may indicate a Quality of Service, QoS, or priority level ensured for the one or more communication flows impacted by the detected link issue.

The last Information Element 506 is dedicated to provide flow information for identifying one or more communication flows (e.g. bearers or links) impacted by the detected link issue. For example, the flow information includes a flow identifier (ID) for identifying the one or more communication flows in Information Element 506 and may include one or more of the radio bearer ID (e.g. DRB/SRB ID), Sidelink, SL, radio bearer ID (e.g. SL DRB ID/SL SRB ID), RLC channel or bearer ID or link ID for identifying a link associated with the detected link issue or path ID (e.g. in case of multiple relay connection for a remote UE) or hop ID (e.g. in case where a remote UE uses several chained relay UEs to reach a destination node). The link ID may be based on the L2_ID of the source node or each link ID/path ID/hop ID list is shared in between the nodes during the connection process.

The link issue signalling messages for providing link issue feedback, relay (re)selection feedback and the link status modification feedback share the same format as FIG. 5, with a different PDU type indicated in the Information Element 501 to indicate whether the link issue signalling message indicates link issue feedback, relay (re)selection feedback, or link status modification feedback.

The link issue signalling message has a flexible size depending on the optional Information Elements included and on the list of bearers or link IDs to be inserted in Information Element 506 and the L2 IDs to be inserted in Information Element 502.

All or part of the information elements described above may be included in different types of container such as MAC-CE specified in TS 38.321, the SRAP control PDU specified in the TS 38.351, a PC5-RRC message specified in the TS 38.331 or a PC5-S message specified in the TS 24.334. All or some of the Information Elements previously described may be embedded to a new signaling or in addition to an existing one.

The MAC-CE specified in TS 38.321 can be used as the container of the link issue signalling message detailed above; it has the possibility of accepting flexible size messages. The link issue signalling message will be located in the payload of the MAC-CE structure. In an alternative embodiment, the PDU type information 501 may be supported by the LCID which indicates the type of conveyed MAC-CE. Consequently, a new LCID value may be defined for each PDU type described above.

The SRAP (adaptation layer) control PDU can be used as the container of the link issue signalling message. The D/C bit specified in the TS 38.351 indicates whether the corresponding SRAP PDU is an SRAP Data PDU or an SRAP Control PDU. The feedback could be sent also using RRC signaling (e.g. PC5-RRC). The signaling message can be sent as an Information Element which can be referred to as a link issue feedback Information Element.

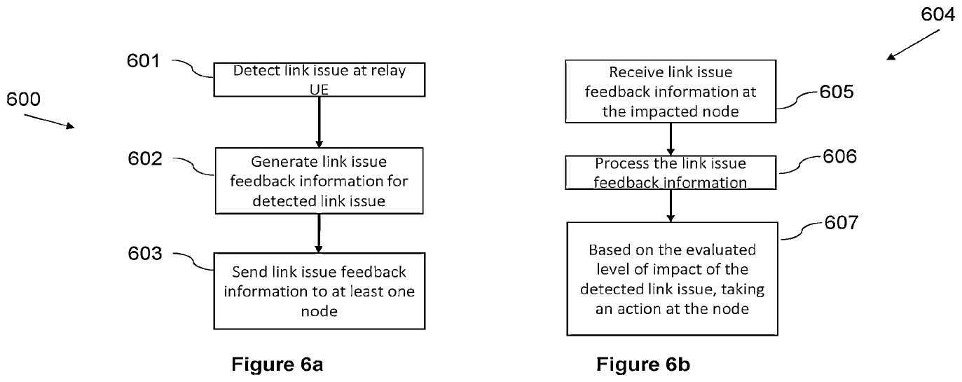

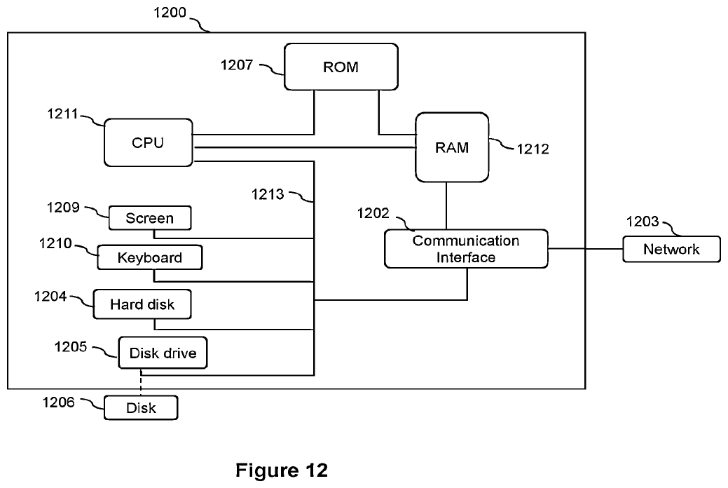

FIG. 6a shows steps of a method 600 for signalling a link issue in a sidelink relay system of a wireless communication system (such as the wireless communication system shown in the FIG. 1 and related Figures) in accordance with embodiments of the invention. Method 600 is performed at the relay UE node. The wireless communication system comprises a relay UE node (for example, relay UE 100 as shown in the Figures) and a plurality of nodes (for example, two or more remote UE nodes such as remote UEs 101, 102, 103, and network node 107 as shown in the Figures). The relay UE node is configured to relay data (e.g. packets) between at least one of the plurality of nodes and at least one other of the plurality of nodes. The relay UE node may be implemented in a communication device 1200 as shown in and described with reference to FIG. 12 below with the method as shown in FIG. 6a being performed by the processing unit 1211.

A link issue is detected at relay UE 100 as mentioned in step 601. In step 602, the relay UE generates or prepares link issue feedback information for the detected link issue. The link issue feedback information includes flow information for identifying one or more communication flows impacted by the detected link issue. At step 603, the relay UE 100 sends the link issue feedback information. In an example, the relay UE 100 sends the link issue feedback information to at least one of the plurality of nodes associated with the one or more communication flows impacted by the detected link issue. The relay UE 100 may identify at least one or more communication flows or paths (e.g. radio bearers or links) that are impacted by the detected link issue so as to identify or determine at least one of the plurality of nodes associated with the one or more communication flows impacted by the detected link issue (i.e. at least one impacted node(s)). For example, once the link issue is detected and the communication flow(s) impacted identified (e.g. the impacted E2E radio bearer(s), RLC bearer/channel(s), PC5 and/or Uu link(s) are identified), mapping tables can be used to identify the impacted node(s) (such as one or more remote UEs or the gNB) as described above with respect to the description of the link issue feedback scenario and the different types of link issues. The impacted node(s) includes at least one of a source node and a destination node. For example, when a sidelink relay connection is established between a source node, the relay UE node and a destination node in the sidelink relay system, detecting a link issue may comprise detecting a link issue associated with at least one of a first link between the source node and the relay node, and a second link between the destination node and the relay node sends the link issue feedback information to at least one of the source node and the destination node. In an example, the relay UE 100 may send the link issue feedback information to all of the nodes connected to the relay UE 100.

In an example, the flow information includes a flow identifier for identifying the one or more communication flows impacted by the detected link issue. The identifier may be one of the following (e.g. based on the type of link issue): DRB ID; SRB ID; SL DRB ID; SL SRB ID; RLC bearer ID; RLC channel ID; link ID (e.g. PC5 ID or Uu ID) for identifying a link associated with the detected link issue.

The link issue feedback information may further include information for identifying a type of the detected link issue (e.g. whether the link issue is one of the following types of link issue: congestion, link degradation, RLF, transient/short-term or long-term/permanent). The information for identifying a type of the detected link issue may include a reason identifier (ID) or another identifier for identifying a type of the detected link issue (e.g. PDU type) as discussed above. The information may also include reason/context information for indicating a reason for or context of the detected link issue. The reason ID may, in addition to identifying the type of the detected link issue, also represent a reason for or context of the detected link issue as discussed above. For example, the reason ID may identify that the link issue is one of the following types of link issue: congestion on a PC5 hop, congestion on a Uu hop, congestion on an E2E Uu RB, congestion on a remote UE E2E RB, congestion on a Uu RLC channel/bearer, congestion on a PC5 RLC channel/bearer, link degradation, link level congestion (on PC5 hop or Uu hop), RLF.

The link issue feedback information may further include at least one identifier, such as the L2 ID for a remote UE or an identifier for the network node gNB, for identifying the at least one of the plurality of nodes to which the link issue feedback information is to be sent. This is also referred to as a destination ID (i.e. the destination of the link issue signalling message).

The link issue feedback information may be included in a link issue signalling message sent by the relay UE 100. The link issue signalling message may have the example format as discussed above with respect to FIG. 5 and FIGS. 11a-11e. With this format, the flow information (e.g. flow identifier) is provided in Information Element 506, the information for identifying a type of the detected link issue is provided in Information Element 503 and at least one identifier for identifying the at least one of the plurality of nodes to which the link issue feedback information is to be sent is provided in Information Element 502 (i.e. the destination ID Information Element). The link issue signalling message may further include a PDU type Information Element 501 for indicating the type of the link issue signalling message: that is, for example, whether the link issue signalling message is a link issue feedback type, a (re)selection feedback type or a link status modification feedback type. Optionally, the link issue signalling message also includes information indicating the QoS or the priority level(s) ensured by the relay node in Information Element 505. Optionally, the link issue signalling message also includes information which provides an indication as to the magnitude or level of the link issue in Information Element 504, such as the available buffer size or the link quality parameters provided or the criticality level which gives the impacted node(s) an explicit view of the buffer status or link quality as determined by the relay UE 100.

The link issue signalling message may be sent by unicast, multicast or broadcast communication. In case the relay UE determines (e.g. using the mapping tables) only one node is impacted by the detected link issue, the relay UE can use unicast to send the link issue feedback information directly to this node. In this case, when the link issue feedback information is sent in a link issue signalling message having a format as shown in FIG. 5, the IE 502 will include only one identifier for identifying the one node. If several nodes are impacted, multicast or groupcast if a group is already defined/created (with specific address) can be used for the set of impacted nodes. In all cases, the link issue feedback information can be sent in a broadcast message and in this case, the impacted node(s) may filter according to RLC ID, bearer or link ID (to check whether the ID in the message corresponds to ID used by the node) instead of using the destination address of the message. The type of communication used (unicast, multicast or broadcast) may also depend on the type of message (MAC CE, RRC, SRAP).

In the link issue feedback scenario discussed above and in an example where the link issue signalling message has a format as shown in FIG. 5 and FIGS. 11a-11e with the PDU type IE 501 indicating a link issue feedback type, the relay UE 100 sets the PDU type in the PDU type Information Element 501 to indicate a link issue feedback type. The reason ID in Information Element 503 is then specified based on the link issue type (congestion, link degradation or link failure) and the corresponding bearers or links that are impacted (e.g. flow ID). A table of reason ID as described above is used to map the issue detected on a bearer or RLC channel or link to a reason. The bearer ID or RLC channel ID or link ID (e.g. flow ID) is specified and added to Information Element 506 of the link issue signalling message according to the link issue type.

The available buffer size or link quality parameters (or other information that indicates the magnitude of the link issue) are added (e.g. in Information Element 504) also in case of congestion at bearers or link degradation issue. The optional Information Elements are added as function of their availability.

The generated link issue feedback information and additional information is then sent in the link issue signalling message to the impacted node(s) (e.g. as in step 603). The container type for the link issue signalling message is chosen by the relay UE 100 as a function of the size, the criticality of the link issue and the type of communication (unicast, multicast or broadcast). The container type may be one of a MAC CE container, a SRAP control PDU, RRC signaling or a PC5 signalling as discussed above. The link issue signalling message may be sent by unicast, or multicast or broadcast based on the type of the detected link issue.

Referring now also to FIG. 6b which shows steps of a method 604 for processing link issue feedback information at an impacted node in a sidelink relay system of a wireless communication system (such as the wireless communication system shown in the FIG. 1 and related Figures) in accordance with embodiments of the invention. The impacted node may be at least one of the plurality of nodes (e.g. a remote UE or a network node) that is impacted by the link issue detected by the relay node (e.g. relay UE 100). The impacted node may be implemented in a communication device 1200 as shown in and described with reference to FIG. 12 below with the method as shown in FIG. 6b being performed by the processing unit 1211.

Link issue feedback information sent by the relay UE 100 is received by the impacted node(s) (e.g. remote UE (such as remote UE 101, 102 and/or 103) and/or gNB 107) in step 605. The link issue feedback information received from the relay UE 100 includes flow information for identifying one or more communication flows impacted by a detected link issue.

At step 606, the impacted node processes the link issue feedback information to determine the one or more communication flows impacted by the detected link issue based on the flow information and to evaluate a level of impact of the detected link issue on data communication at the node over the one or more determined communication flows. For example, the impact may be on data transmission by the node or data reception at the node. In an example, the link issue is at least one of a plurality of different types of link issue, the plurality of types of link issue including: handover, congestion, link degradation, RLF, transient/short-term or long-term/permanent link issue. The link issue feedback information may further include information (such as the reason ID or PDU type as discussed above) for identifying the type of link issue which can be used by the node to evaluate the level of impact of the detected link issue. The reason ID may, in addition to identifying the type of the detected link issue, also represent a reason for or context of the detected link issue as discussed above. The flow information may include the flow identifier for identifying the one or more communication flows impacted by the detected link issue as discussed above. The impacted node may then evaluate the level of impact of the detected link issue by determining the one or more communication flows that are impacted from the flow information, and may also perform the evaluation based on the type of link issue.

At step 607, based on the evaluated level of impact of the detected link issue, the impacted node takes an action(s) or performs an operation(s) at the impacted node. An action or operation is performed to mitigate the impact of the detected link issue in the event the evaluation determines the evaluated level of impact reaches a certain threshold. The action or operation may include releasing a link associated with the one or more impacted communication flows and (re)selection of a relay node, waiting for new link issue feedback information and adapting (e.g. restarting or resuming) transmission of data (packets) by the node over the one or more impacted communication flows. It is noted that although step 607 and 606 have been shown as separate steps, step 607 may be performed as part of the processing step 606.

As described above, the link issue feedback information received at the node may be included in a link issue signalling message which may further include PDU type information for indicating the type of the link issue signalling message. The link issue signalling message can be one of: a link issue feedback type, a (re)selection feedback type or a link status modification feedback type. The operations performed at step 607 may comprise performing operations or taking actions at the node based on the type of link issue signalling message determined based on the PDU type information and the evaluated level of impact of the detected link issue.

As discussed above with respect to step 605, the link issue signalling message is received by the impacted node(s). After receiving the link issue signalling message, the processing of the link issue feedback information (e.g. as in step 606) may include identifying the PDU type from Information Element 501 to know the action to be taken. If it is a link issue feedback, the impacted node(s) will acknowledge about the link issue with no required action from the impacted node(s). Next, the impacted node(s) read(s) the remaining Information Elements to recognize the link issue type; whether it is at bearer level or RLC channel level or link level specified in the reason ID. And the associated Information Element (e.g. IE 506) corresponding to the identity of the bearers or links with issues. After collecting the information from the signalling message, the impacted node(s) begin(s) the feedback processing consisting of evaluating the link issue and its degree of impact on its transmission and the decision to be taken or not based on the received information in the link issue signalling message.

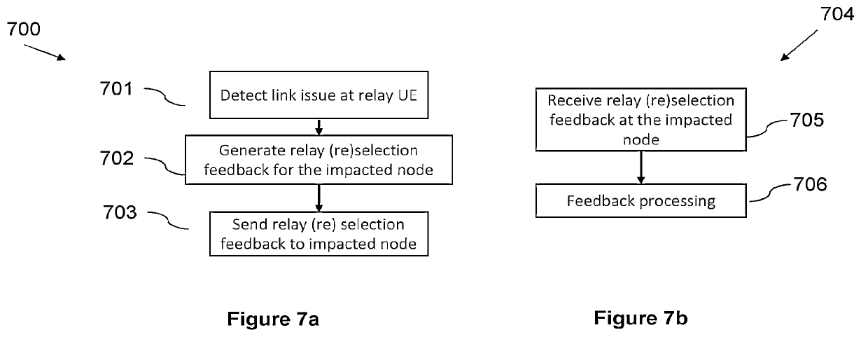

FIG. 7a shows steps of a method 700 for generating a link issue signalling message including information for indicating relay (re)selection feedback in a sidelink relay system of a wireless communication system (such as the wireless communication system shown in the FIG. 1 and related Figures) in accordance with embodiments of the invention. FIG. 7b shows steps of a method 704 for processing information included in a link issue signalling message at an impacted node in a sidelink relay system of a wireless communication system (such as the of a wireless communication system shown in the FIG. 1 and related Figures) in accordance with embodiments of the invention. Method 700 is performed at the relay UE node such as relay UE 100 of FIG. 1 and related Figures and method 704 is performed at a remote UE node that is impacted by the link issue detected by the relay node (e.g. relay UE 100). Each of the relay UE node and the impacted node may be implemented in a communication device 1200 as shown in and described with reference to FIG. 12 below.

With reference firstly to FIG. 7a, in this example, and after detecting a link issue at the relay UE in step 701, the relay UE 100 evaluates the situation from its side and decides to trigger the remote UE for a relay (re)selection. In other words, the relay UE may consider high level of criticality that needs a prompt action to alleviate the link issue. This case is applied when a remote UE is the impacted node.

The relay prepares or generates then the information for the link issue signalling message for indicating relay (re)selection feedback in step 702, similarly to generation of the information for the link issue signalling message for indicating the link issue feedback (e.g. as discussed generally with respect to step 602). For example, the link issue signalling message generated in step 702 may include the link issue feedback information including flow information as discussed above and may also include a different PDU type indicating a relay (re)selection triggering from relay UE.

In another example, the link issue signalling message for indicating relay (re)selection generated by the UE relay 100 in step 702 may include link issue feedback information including information for identifying a type of the detected link issue (e.g. different types of link issue including: congestion, link degradation, Radio Link Failure, RLF). The information for identifying a type of the detected link issue may include a reason identifier or another identifier for identifying a type of the detected link issue. The information may also include reason/context information for indicating a reason for or context of the detected link issue. The reason ID may, in addition to identifying the type of link issue, may also indicate a reason for or context of the detected link issue as discussed above. In this example, the link issue signalling message for indicating relay (re)selection may not include the flow information.

The link issue signalling message or feedback is then sent to the impacted remote UE in step 703.

As said previously, the container of the link issue signalling message depends from its size, the criticality of the link issue that may require low latency.

Referring now also to FIG. 7b, the remote UE, receiving the link issue signalling message for indicating relay (re)selection feedback from its relay UE in step 705, identifies the PDU type (e.g. in Information Element 501 of the message as shown in FIG. 5 and FIGS. 11a to 11e), that in this case asks for or relates to a relay (re)selection. The remote UE reads the next Information Elements of the link issue signalling message in order to identify the link issue reason and the corresponding bearers or links with issue. In the feedback processing step 706, the remote UE releases the PC5 link with the relay UE which may be the link impacted by the detected link issue in case of a link failure or may contain one or more communication flows (e.g. RLC channels) impacted by the detected link issue and proceeds for a relay (re)selection. In an example implementation where the link issue signalling message for indicating relay (re)selection does not include flow information but includes a reason ID which identifies the type of link issue and may also indicate a reason for or context of the detected link issue (as discussed above), in response to receiving the link issue signalling message, the remote UE may release the PC5 link and initiate a (re)selection procedure based on the reason ID included in the message.

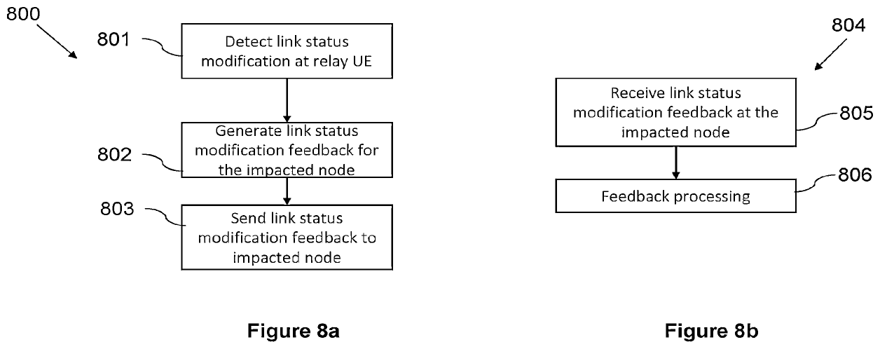

FIG. 8a shows steps of a method 800 for generating a link issue signalling message including information for indicating link status modification feedback in a sidelink relay system of a wireless communication system (such as the wireless communication system shown in the FIG. 1 and related Figures) in accordance with embodiments of the invention. FIG. 8b shows steps of a method 804 for processing information included in a link issue signalling message at an impacted node in a sidelink relay system of a wireless communication system (such as the wireless communication system shown in the FIG. 1 and related Figures) in accordance with embodiments of the invention. Method 800 is performed at the relay UE node such as relay UE 100 of FIG. 1 and related Figures and method 804 is performed at a node (such as at least one of the plurality of nodes (e.g. a remote UE or a network node) that is impacted by the link issue detected by the relay node (e.g. relay UE 100)). Each of the relay UE node and the impacted node may be implemented in a communication device 1200 as shown in and described with reference to FIG. 12 below.

On detecting a link issue, the relay UE 100 may determine (e.g. as discussed above using a timer or counter) whether the link issue is a transient or short-term link issue (e.g. the link has been or will shortly be recovered) or whether it is a long-term link issue (e.g. a link issue which gets worse and which results in not being able to recover the link issue (i.e. a permanent link issue)). When the relay UE 100 determines that the link has been recovered or cannot be recovered, the relay UE 100 sends (e.g. to the impacted nodes) link status modification feedback. In this case, detecting a link issue, includes detecting, at the relay UE 100, a link status modification in step 801. Information for the link issue signalling message for indicating a link status modification feedback is then generated or prepared in step 802. For example, the link issue signalling message generated in step 802 includes the link issue feedback information including flow information as discussed above but the PDU type in this case corresponds to a link status modification feedback. The next Information Elements (e.g. Information Elements 502-506 of the link issue signalling message of FIG. 5 and FIGS. 11a-11e) may be updated as function of the link status modification. In other words, the information provided in Information Elements of the link issue signalling message (e.g. IEs 502-506 of FIG. 5) will be updated based on the current status of a detected link issue.

In case of congestion or link degradation, the Information Elements associated to the available buffer size and the link quality parameters may change as function of the criticality update of the link issue: i.e., for a link degradation issue, if the link quality parameter assessed goes from weak to medium, the link status modification feedback will send the same Information Elements as for a link issue feedback with an update of the link quality parameters Information Element (IE 504).

A congestion detected to a specific bearer or RLC channel may become worse and then affects all RLC channels conveyed on a link (link level congestion), and thus, in a way of optimization, the link status modification feedback may be sent with the identification of the link experiencing an issue instead of an ID list of all the impacted channels. Moreover, the link status modification feedback may be sent without a notification of the available buffer size and thus, announcing to the impacted node(s), that the link issue has been intensified and it becomes a link level congestion.

The link issue signalling message for indicating link status modification feedback is then sent to the impacted node(s) in step 803.

Referring now also to FIG. 8b, the impacted node(s) receive(s) link issue signalling message(s) for indicating link status modification feedback in step 804 and identifies in its PDU type (e.g. in Information Element 501 of the message as shown in FIG. 5 and FIGS. 11a to 11e) that the feedback is concerning a link status modification. If the available buffer size or the link quality parameters do not figure or are not included in the feedback, it may indicate that it is still or has become a link level congestion or link failure. The reason ID in Information Element 503 identifies the type of the link issue and the related bearers/channels or links that are impacted: e.g., a congestion occurring at Uu RLC channel in uplink may degenerate and the number of PC5 RLC channels that are impacted may increase. The flow information in Information Element 506 identifies the communication flow(s) impacted. Thus, a link status modification may be sent from the side of relay UE to the remote UE in order to show that it is still a congestion at Uu RLC channel but the impacted PC5 RLC channels have increased.

The feedback processing is performed by the impacted node(s) in step 805 to re-evaluate the situation of the link issue. A link status modification feedback that indicates that a link issue has ended may lead to the relay node to reset the timer or the counter used to determine if the congestion is a short-term or a long-term congestion (the congestion is considered as a long-term congestion in case the time reaches a predefined threshold).

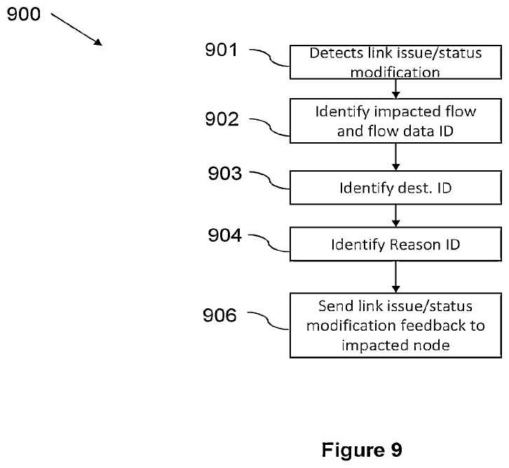

FIG. 9 shows steps of a method 900 for signalling a link issue in a sidelink relay system of a wireless communication system (such as the wireless communication system shown in the FIG. 1 and related Figures) in accordance with embodiments of the invention. Method 900 is performed at the relay UE node. The wireless communication system comprises a relay UE node (for example, relay UE 100 as shown in the Figures) and a plurality of nodes (for example, two or more remote UE nodes such as remote UEs 101, 102, 103, and network node 107 as shown in the Figures). The relay UE node may be implemented in a communication device 1200 as shown in and described with reference to FIG. 12 below with the method as shown in FIG. 9 being performed by the processing unit 1211. With the example method 900 of FIG. 9, the relay UE 100 generates a link issue signalling message (e.g. having a format as shown in and described with respect to FIG. 5 and FIGS. 11a-11e) which includes information for signalling link issue/relay (re)selection/link status modification feedback to the impacted node (for example, in accordance with the general steps 601-603 of FIG. 6a).

The relay UE 100 detects a link issue or link status modification (e.g. in other words a change in link status of a previously detected link issue) in step 901. The steps 903-904 concern the desired information (e.g. for Information Elements 502, 503, 504, 506 of the format shown in FIG. 5) to be identified by the relay UE 100 so as to generate a link issue signalling message according to the example format shown in FIG. 5.

The relay UE 100 identifies the one or more flows or communication flows that are impacted by the link issue in step 902, whether one or more radio bearers or RLC channels or a links. The identification of the impacted flow(s) allows the relay UE 100 to define or determine the impacted node(s): e.g. to define or identify the source node (or transmitter) and/or destination node (or receiver) that is to be sent the link issue feedback information included in the link issue signalling message. The relay UE 100 also determines the flow information (also referred to as flow ID or flow data ID) identifying the one or more communication flows (e.g. radio bearers or links) that have been identified as being impacted by the detected link issue. For example, the flow data ID considers the Radio bearer ID or RLC bearer ID in case of congestion at RB level or RLC channel level. The link level congestion and the link failure need to identify the source of the link issue: for example, for this type of link issue, the flow information includes a link identifier (PC5 link ID or Uu link ID). A link failure at Uu is identified by the L2-ID of the relay UE. Furthermore, the radio bearer ID impacted by the link level issue are reported in the flow information or flow data ID feedback (e.g. in Information Element 506). When a number of RLC channels or bearers are affected, a list of the affected RLC channels/bearers (e.g. a list of the RLC channel/bearer IDs) may be reported in the flow information (e.g. IE 506).

The link issue feedback information included in the link issue signalling message further includes identifier(s) (e.g. in Information Element 502) for identifying the determined impacted node(s) to which the link issue feedback information is to be sent. When the impacted node is a remote UE, the L2-ID of the remote UE is specified by the Uu SRAP layer 203 in case of U2N relay (second PC5 SRAP layer in case of U2U relay). In case of uplink traffic, this L2-ID is the destination ID identified in step 903 and is included in the Information Element 502. In case of downlink, the gNB is identified as the destination of the feedback and the gNB ID is included in Information Element 502. For U2U relay, the identity information or identifiers of the source UE and the destination or target UE are candidate information to be included in the adaptation layer and thus, in case of the link issue signalling message being sent to the source UE, the corresponding destination ID in the Information Element 502 is the L2-ID of the source UE. In the case of the link issue signalling message being sent to the destination UE, the corresponding destination ID in the Information Element 502 is the L2-ID of the destination UE.

A link level congestion or link failure means a global link issue that impacts a series of RLC channels, radio bearers, and destination nodes which are determined by the Uu SRAP layer 203 for U2N relay (or second PC5 SRAP layer in case of U2U relay) and the mapping tables configured in these SRAP entities as described above. Thus, a list of destination IDs of all of the impacted nodes may be provided as described previously.

The reason ID for identifying a type of link issue is identified or determined and specified in Information Element 503 as in step 904. After detecting the impacted flow, the reason of the link issue or link status modification can be known by the relay UE 100 and the relay UE 100 can determine an ID (e.g. a number or other identifier) that indicates or is associated with the type of the link issue and may also indicate a reason of the congestion for such link issue type (bearer, RLC channel or link level). For example, a reason ID table(s) listing different reason IDs for different types of link issues can be provided at the relay UE 100 as discussed above (see for example the examples given in Tables 4 and 5). If the relay UE 100 cannot recognize the reason of the link issue or link status modification, a specific code may be used as reason ID. For instance, the reason ID allocated may correspond to no reason identified+link issue type: e.g., if a link failure occurs at the PC5 link and there is no reason to explain the link failure, the relay UE 100 will send a reason ID that matches or corresponds to the reason ‘no recognized reason with a PC5 link failure’.

The information for Information Elements 502, 503, and 506 are identified by the relay UE 100 in steps 903-904 and incorporated in the link issue signalling message with additional Information Elements that are optional and known by the relay UE 100, such as the buffer status or link quality parameters (for Information Element 504) and/or QoS/priority level for Information Element (505).

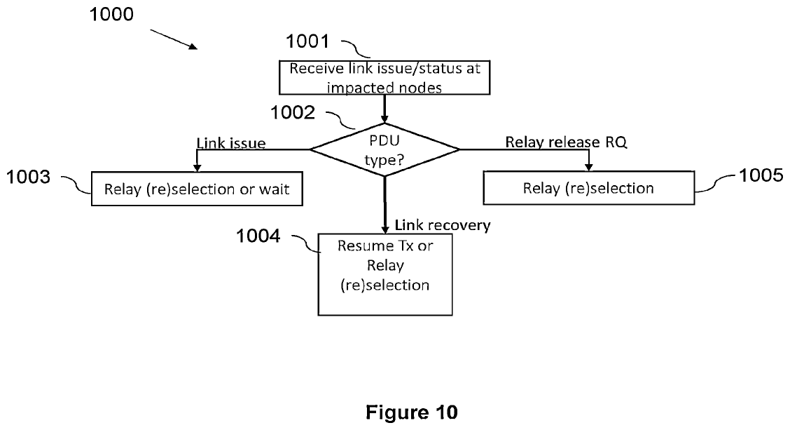

FIG. 10 shows steps of a method 1000 for processing link issue feedback information at an impacted node in a sidelink relay system of a wireless communication system (such as the wireless communication system shown in the FIG. 1 and related Figures) in accordance with embodiments of the invention. For example, FIG. 10 illustrates how the impacted nodes make a decision and perform operations (e.g. as per steps 606-607 in FIG. 6b) after receiving the feedback from the relay UE 100 in the link issue signalling message. The impacted node may be at least one of the plurality of nodes (e.g. a remote UE or a network node) that is impacted by the link issue detected by the relay node (e.g. relay UE 100). The impacted node may be implemented in a communication device 1200 as shown in and described with reference to FIG. 12 below with the method as shown in FIG. 10 being performed by the processing unit 1211.

The impacted node(s) receive, at step 1001, the link issue signalling message including the feedback information. As discussed above, the link issue signalling message may be one of three different types based on the type of feedback the link issue signalling message is signalling. The link issue signalling message may be one of: a link issue feedback type, a (re)selection feedback type or a link status modification feedback type. In an example, the link issue signalling message includes (in addition to the link issue feedback information) PDU type information for indicating the type of the link issue signalling message. The impacted node(s) identify or determine the type of link issue signalling message based on the PDU type information in step 1002.

The PDU type could be a link issue feedback to inform the impacted node(s) about the current situation. In response to receiving a link issue signalling message of the link issue feedback type (i.e. for signalling link issue feedback), the impacted node(s) is not required to take an action and thus it can wait before taking any action (step 1003, following the ‘Link issue’ branch from step 1002). However, it can also trigger a relay (re)selection after a release as also indicated in step 1003.

For a relay (re)selection feedback, the remote UE which is the destination of the link issue signalling message including the feedback is asked or requested to release the link which corresponds to the communication flow impacted by the detected link issue and to perform a relay (re)selection as in step 1005 (following the ‘Relay release RQ’ branch from step 1002). Thus, on receipt of the link issue signalling message, the impacted remote UE, releases the impacted link and performs a relay (re)selection.

A link status modification feedback could be sent as a third option by the relay UE 100. In this case, the link issue signalling message including the link status modification feedback announces a link recovery, and the impacted node(s) can resume its transmissions in step 1004 (following the ‘Link recovery’ branch from step 1002). For example, the impacted node(s) can restart transmission of data (e.g. packets) over the impacted one or more communication flows. If the link status modification feedback reports a worse situation of the link issue, a relay (re)selection can be considered at step 1004 as in step 1005.

According to some aspects, discussed in the above description, the link issue feedback signalling may be used by a relay UE to inform a remote UE that all or part of its communications are impacted by an ongoing link issue (e.g. RLF, congestion). The impacted remote UE may for instance use this feedback information for relay (re)selection as discussed above (e.g. with respect to FIGS. 6b, 7b and FIG. 10).

According to another aspect, a relay UE may experience some drawbacks that restrict its current capacity of relaying, e.g. the actual relaying capacity may be impacted by radio conditions (e.g. RSRP, SINR . . . ) or the actual load of the relay UE. Such relaying capacity restrictions may lead to further link issue(s) (such as congestion) if a candidate remote UE that is considering connecting to the relay UE does not take such restrictions into consideration and still requests connection to the relay UE and/or if a link with an already connected remote UE is not modified or released.

It may thus be valuable for the relay UE to consider any capacity restrictions which could result in a link issue should new connections to one or more remote UEs be allowed or accepted or should link modification with an already connected remote UE be allowed or accepted or should a link with an already connected remote UE not be modified or released and to share such actual capacity of relaying with the remote UE in a proactive way (for example, at the discovery stage or during a link management process, such as a direct link process or a direct communication process) to ensure that such a link issue does not arise. For example, by ensuring a candidate remote UE does not create any link issue by connecting to the relay UE or by modifying or releasing a link with an already connected remote UE.

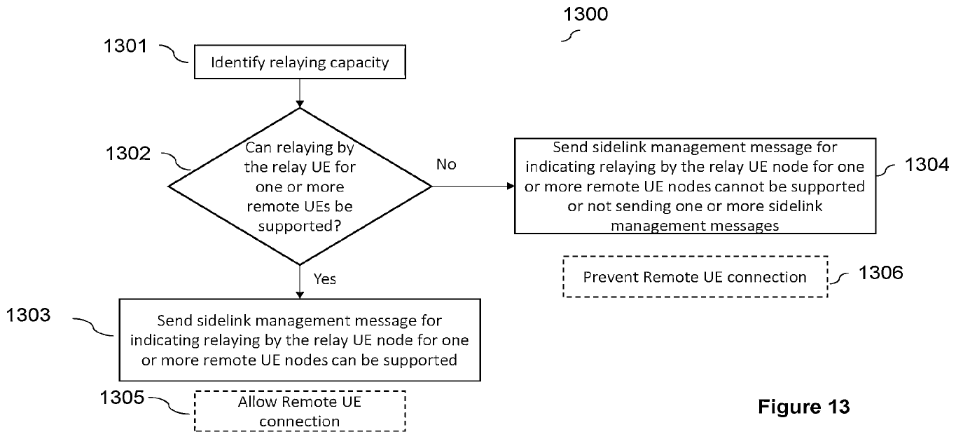

FIG. 13 shows steps of a method 1300 performed by a relay User Equipment, UE, node of a wireless communication system (such as the wireless communication system shown in the FIG. 1 and related Figures) in accordance with embodiments of the invention. Method 1300 is performed at the relay UE node. The wireless communication system comprises a relay UE node (for example, relay UE 100 as shown in the FIG. 1 and related Figures) and a plurality of nodes (for example, one or more remote UE nodes such as remote UEs 101, 102, 103, and network node 107 as shown in the FIG. 1 and related Figures). The relay UE node is configured to relay data (e.g. packets) between at least one of the plurality of nodes and at least one other of the plurality of nodes. The relay UE node may be implemented in a communication device 1200 as shown in and described with reference to FIG. 12 below with the method as shown in FIG. 13 being performed by the processing unit 1211.

The method shown in FIG. 13 enables the relay UE node to manage new and existing remote UE connection(s), during a sidelink management process such as a discovery process or a link management process (such as a direct link process or a direct communication process), according to the actual relaying capacity of a relay UE node. This method may also include the sharing of such relaying capacity between the relay UE node and the remote UE node.

A 5G Proximity-based Services (ProSe) U2N/U2U relay UE supports two models of discovery, i.e. model A and model B as defined in 3GPP TS 23.304, V17.1.1. Model A uses a single discovery protocol message (i.e. Announcement message sent by the Relay UE acting as the announcing UE) while the model B uses two discovery protocol messages (i.e. Solicitation message sent by the remote UE acting as the discoverer UE and Response message from the relay UE acting as the discoveree UE). In the latter case for model B, the discoverer UE may indicate in its discovery solicitation or request message its interest to have a status of the requested relay UE(s) for instance concerning the link(s) or the actual load of the relay UE or the connectivity with the other UEs. The discovery solicitation message may be sent via broadcast, unicast or groupcast.

A relay UE may also support a link management process such as a direct link process or procedure for establishing a direct link between a UE node and another UE node (such as the Direct Link process defined in 3GPP TS 24.587, V17.5.0) and/or a direct communication process or procedure for direct communication between two or more UEs (such as the Direct Communication process defined in 3GPP TS 23.304, V17.1.1).

In the Direct Link process, a remote UE node sends a direct link establishment request message. If, on receipt of the direct link establishment request message, a relay UE node accepts the request to establish a direct link (e.g. over a PC5 link) with the remote UE node, the relay UE node sends a direct link establishment accept message in response. In the UE-to-UE relaying or multi-hop UE-to-Network (i.e. a remote UE using several successive relay UEs to reach a gNB) cases, if, on receipt of the direct link establishment request message, a relay UE node accepts the request to establish a direct link (e.g. over a PC5 link) with the remote UE node, the relay UE forwards the direct link establishment request message or sends its own new direct link establishment request message to establish a direct link connection (e.g. over another PC5 link) with the target UE or another relay UE. The relay UE will send a direct link establishment accept message in response to the remote UE once its own direct link establishment request will be accepted by the target UE or by the other relay UE or to save time in the establishment process, the relay UE may accept the remote UE direct link establishment request only based on its own criteria even if it has to later release the direct link connection with the remote UE if the direct link establishment with the target UE or the other relay UE is rejected. If, on receipt of the direct link establishment request message, a relay UE node does not accept the request to establish a direct link (e.g. over a PC5 link) with the remote UE node, the relay UE node sends a direct link establishment reject message in response. The Direct Link process also provides for a direct link modification request to be sent by a UE (e.g. the relay UE) to another peer UE (e.g. a UE already connected to the relay UE) to initiate the direct link modification procedure (e.g. to modify the PC5 link between the relay UE node and the remote UE node). The Direct Link process also provides for a direct link release request to be sent by a UE (e.g. the relay UE) to another peer UE (e.g. a UE already connected to the relay UE) to initiate the direct link release procedure (e.g. to release the PC5 link between the relay UE node and the remote UE node).

In the Direct Communication process, a remote UE node sends a direct communication request message. If, on receipt of the direct communication request message, a relay UE node accepts the request to establish a direct communication (e.g. over a PC5 link) with the remote UE node, the relay UE node sends a direct communication accept message in response. In the UE-to-UE relaying or multi-hop UE-to-Network cases, if, on receipt of the direct communication request message, a relay UE node accepts the request to establish a direct communication (e.g. over a PC5 link) with the remote UE node, the relay UE forwards the direct communication request message or sends its own new direct communication request message to establish a direct communication (e.g. over another PC5 link) with the target UE or another relay UE. The relay UE will send a direct communication accept message in response to the remote UE once its own direct communication request will be accepted by the target UE or by the other relay UE or to save time in the establishment process, the relay UE may accept the remote UE direct communication request only based on its own criteria even if it has to later release the direct communication with the remote UE if the direct communication with the target UE or the other relay UE is rejected. If, on receipt of the direct communication request message, a relay UE node does not accept the request to establish a direct link (e.g. over a PC5 link) with the remote UE node, the relay UE node sends a direct communication reject message in response.

The relay UE node in FIG. 13 identifies or checks its relaying capacity for relaying data in step 1301. For example, the relay UE node identifies its current or actual relaying capacity. The relay UE node may check its relaying capacity periodically or in response to a trigger event. The trigger event may include at least one of: receipt of a discovery solicitation message, or receipt of a direct link establishment/modification request, or receipt of a Direct Communication request or based on measurements results (e.g. the measurement results indicate a significant change in the capacity of the relay UE node (e.g. decrease in capacity beyond a certain level or increase in capacity beyond a certain level) that merits the relay UE node proactively notifying remote UE nodes, that are in proximity to the relay UE node, of the change).The relay UE node may identify its relaying capacity by determining or checking one or more relaying parameters associated with current relaying of data by the relay UE node. The one or more different relaying parameters may include one or more of current load of the relay UE node, the number of currently connected remote UE nodes, radio conditions (or link quality) at each communication link (e.g. PC5 link or Uu link) between the relay UE node and one or more nodes for which the relay UE node is relaying data (which may be based on measurements such as RSRP, SINR, RSSI, RSRQ etc. measurements for PC5 and Uu links), level of QoS, bitrate for each of one or more communication flows currently served by the relay UE node, and/or network load which may be based on the channel busy ratio (CBR) and/or the channel occupancy ratio (CR) for each band/pool currently used by the relay UE node for the data relaying.

At step 1302, the relay UE node determines whether relaying by the relay UE node for one or more remote UE nodes (e.g. one or more remote UE nodes that are new or additional to those already served by the relay UE node and/or one or more remote UE nodes that may already be connected to the relay UE node) can be supported without risk of a link issue. For example, the relay UE checks if some potential risk of link issue may result from the connection of one or more new or additional remote UEs and so checks whether a connection with a new remote UE node can be accepted. In another example, the relay UE checks if some potential risk of link issue may result from an existing connection with one or more remote UEs and so checks whether the existing connection needs to be modified or released or checks whether the modification request from a remote UE for an existing connection can be accepted.

In a case where the relay UE node determines, at step 1302, that relaying by the relay UE node for one or more remote UE nodes cannot be supported without a risk of link issue, the relay UE node may decide to prevent new remote UE connection(s) or prevent modification of existing remote UE connection(s) or to modify or release existing remote UE connection(s) to avoid any risk of a link issue in the future.

At step 1304, in one example, in response to determining relaying by the relay UE node cannot be supported for one or more remote UE nodes, the relay UE node sends a sidelink management message for indicating relaying by the relay UE node for one or more remote UE nodes cannot be supported (e.g. so as to prevent remote UE connection(s) as indicated by box 1306). The sidelink management message may include relaying capacity information indicating relaying capacity (e.g. the current relaying capacity) of the relay UE node for relaying data by the relay UE node. In an alternative example at step 1304, in response to determining relaying by the relay UE node cannot be supported for one or more remote UE nodes, the relay UE node does not send one or more sidelink management messages: for example, the relay UE node may change (e.g. stop) the sidelink management process performed at the relay UE node so as to stop sending one or more sidelink management messages.

In an example where the relay UE node supports (e.g. is performing) a discovery process, the sidelink management message is a discovery message and the relay UE node may send a discovery message indicating relaying by the relay UE node for one or more new remote UE nodes cannot be supported (e.g. so as to prevent remote UE connection(s) as indicated by box 1306). The discovery message may include relaying capacity information indicating relaying capacity (e.g. the current relaying capacity) of the relay UE node for relaying data by the relay UE node. In an alternative example, the relay UE node may not send or stop sending or forwarding (e.g. to a remote UE or Target UE or subsequent relay UE), one or more discovery messages: i.e. the relay UE node may change (e.g. stop) the discovery process performed at the relay UE node so as to stop sending any announcement message (for discovery model A as defined in 3GPP TS 23.304, V17.1.1) or any response message to a received discovery solicitation message (for discovery model B as defined in 3GPP TS 23.304, V17.1.1). By stopping sending the discovery messages, the UE relay node can prevent new remote UE connections as the UEs in the vicinity of the relay UE node (e.g. relay UE 100) will not receive information from the relay UE node and so will therefore not consider the relay UE when performing relay selection.

In an example where the relay UE node supports (e.g. is performing) a link management process, such as Direct Link process or a Direct Communication process, the sidelink management message is a link management message (e.g. a direct link message or a direct communication message, respectively) and, in response to determining relaying by the relay UE node cannot be supported for one or more remote UE nodes, the relay UE node may send a link management message, like for instance a Direct link establishment reject message for the Direct Link process or a Direct Communication reject message for the Direct Communication process, indicating relaying by the relay UE node for one or more remote UE nodes cannot be supported (e.g. so as to prevent remote UE connection(s) as indicated by box 1306). The link management message may include relaying capacity information indicating relaying capacity (e.g. the current relaying capacity) of the relay UE node for relaying data by the relay UE node. The link management message may be sent in response to a link management request message. For example, the Direct link establishment reject message for the Direct Link process may be sent in response to a Direct link establishment request message. The Direct Communication reject message for the Direct Communication process may be sent in response to a Direct Communication request message. The relaying capacity information may for instance advise remote UE on which conditions a new connection may be accepted by the relay UE.

In the case where the relay UE node supports the Direct Link process, in an alternative example, in response to determining relaying by the relay UE node cannot be supported, the relay UE node may send to an already connected remote UE node a link management message indicating relaying by the relay UE node for one or more remote UE nodes can no longer be supported, like for instance a Direct link modification request message, for requesting modification of a link (i.e PC5 link) between the relay UE node and the connected remote UE node or a Direct link release request message, for requesting release of a link (i.e PC5 link) between the relay UE node and the connected remote UE node. The Direct link modification request message and/or the Direct link release request message may include relaying capacity information indicating relaying capacity (e.g. the current relaying capacity) of the relay UE node for relaying data by the relay UE node.

Alternatively and as with the discovery process, the relay UE node may not send, or forward (e.g. to a remote UE or Target UE or subsequent relay UE), one or more link management messages, such as link establishment messages: i.e. the relay UE node may change (e.g. stop) the link management or establishment process performed at the relay UE node so as to stop sending any response message to a received Direct link establishment request (defined in 3GPP TS 24.587, V17.5.0) or any response message to a received Direct Communication request message (as defined in 3GPP TS 23.304, V17.1.1). By stopping sending link establishment messages, the UE relay node can prevent new remote UE connections to UEs in the vicinity of the relay UE node (e.g. relay UE 100).

The relaying capacity information, included in the sidelink management message (e.g. in the discovery message or in the link management message), sent by the relay UE node in the case where the relay UE node determines, at step 1302, that relaying by the relay UE node for one or more remote UE nodes cannot be supported, may include one or more of the information included in the relaying capacity Information Element as discussed below.

Thus, two example options are possible for step 1304:
The relay UE may no longer perform the sidelink management process, such as the Direct Link process or the Direct Communication process or the discovery process, i.e. the relay UE no longer sends any announcement message (for model A) or any response message (for model B);
The relay UE may indicate that one or more remote UE nodes cannot be supported in a sidelink management message. In addition, the relay UE may share its relaying capacity with the Remote UE by adding a relaying capacity Information Element (as discussed below) to the sidelink management message (e.g. discovery message or link management message) sent to a remote UE.

In a case where the relay UE node determines, at step 1302, that relaying by the relay UE node for one or more remote UE nodes can be supported without risk of link issue, the relay UE node sends, at step 1303, a sidelink management message for indicating relaying by the relay UE node for one or more remote UE nodes can be supported (e.g. so as to allow or enable remote UE connection(s) as indicated by box 1305). The sidelink management message may include relaying capacity information indicating relaying capacity (e.g. the current relaying capacity) of the relay UE node for relaying data by the relay UE node.

In an example where the relay UE node supports (e.g. is performing) a discovery process, the sidelink management message is a discovery message and the relay UE node may send a discovery message indicating relaying by the relay UE node for one or more remote UE nodes can be supported (e.g. so as to allow or enable remote UE connection(s) as indicated by box 1305). Thus, in this case, the relay UE node may perform the discovery process in an ordinary manner at step 1303. The discovery message sent by the relay UE node may be sent by broadcast or as an announcement message (for discovery model A as defined in 3GPP TS 23.304, V17.1.1) or as a response message in response to a discovery solicitation message received from a remote UE node (for discovery model B as defined in 3GPP TS 23.304, V17.1.1). The discovery message may include relaying capacity information indicating relaying capacity (e.g. the current relaying capacity) of the relay UE node for relaying data by the relay UE node.

In an example where the relay UE node supports (e.g. is performing) a link management process, such as Direct Link process or a Direct Communication process, the sidelink management message is a link management message (e.g. a direct link message or a direct communication message, respectively) and in a case where the relay UE node determines, at step 1302, that relaying by the relay UE node for one or more remote UE nodes can be supported without risk of link issue, the relay UE node sends, at step 1303, a link management message indicating relaying by the relay UE node for one or more remote UE nodes can be supported (e.g. so as to allow or enable remote UE connection(s) as indicated by box 1305). Thus, in this case, the relay UE node may perform the link establishment process in an ordinary manner at step 1303. The link management message may be sent in response to a link management request message. In other words, the link management message sent by the relay UE node may be sent as a response message (e.g. a Direct link establishment accept message) in response to a received Direct link establishment request (defined in 3GPP TS 24.587, V17.5.0) or may be sent as a response message (e.g. a Direct link modification accept message) in response to a received Direct link modification request (defined in 3GPP TS 24.587, V17.5.0) or may be sent as a response message (e.g. a Direct Communication accept message) in response to a received Direct Communication request message (as defined in 3GPP TS 23.304, V17.1.1) from a remote UE node. In the UE-to-UE relaying or multi-hop UE-to-Network cases, if, on receipt of the link management request message (e.g. a Direct link establishment request message or a Direct Communication request message), a relay UE node accepts the request to establish a direct link or direct communication with the remote UE node, the relay UE may forward the link management request message or send its own new link management request message (e.g. Direct link establishment request message or Direct Communication request message) to establish a direct link or direct communication (e.g. over another PC5 link) with the target UE or another relay UE. The link management message may include relaying capacity information indicating relaying capacity (e.g. the current relaying capacity) of the relay UE node for relaying data by the relay UE node.

The relaying capacity information that may be included in the sidelink management message (e.g. in the discovery message or in the link management message sent by the relay UE node) in the case where the relay UE node determines, at step 1302, that relaying by the relay UE node for one or more remote UE nodes can be supported (and also in the case where the relay UE node determines, at step 1302, that relaying by the relay UE node for one or more remote UE nodes cannot be supported), may include one or more of the information included in the relaying capacity Information Element as discussed below. Thus, the relay UE may share its relaying capacity with the remote UE by adding a relaying capacity Information Element to the sidelink management message (e.g. the discovery message or the link management message) sent to a Remote UE. The relaying capacity Information Element shared by the Relay UE with the Remote UE may include all or part of the following information:
New connection accepted information: This information shows the ability for the Relay UE to accept new remote UE connection(s). For example, this information indicates whether the relay UE node can accept or not a new connection to a new remote UE node. For instance, this information may be a Boolean parameter. In an example, ‘True’ may indicate accept and ‘False’ may indicate cannot accept. Alternatively, one bit having the value ‘1’ or ‘0’ may indicate whether the UE node can accept or not a new connection.
Relay Load information: This information reflects the relay UE load (e.g. current load of the relay UE node). The relay UE load may be represented in terms of connected remote UEs. For instance, this information may relate to the actual number of remote UEs connected to the relay UE, or any information that would reflect this number, e.g. a load level (Low/medium/High). In one example, this relay load information may reflect the number of new connected remote UEs the relay UE may accept. In another example, this relay load information may indicate the number of remote UEs currently connected to the relay UE and also the maximum number of remote UEs the relay UE may accept.
Served QoS information: This information relates to the level(s) of QoS for the one or more flows currently accommodated by the relay UE, as the relay UE may serve several QoS flows with certain priority levels. For example, this QoS information indicates a respective QoS level of one or more communication flows currently served or supported by the relay UE node. The Served QoS information may include the list of all or part of the QoS levels served by the relay UE, or a list of all or part of the QoS levels the relay UE would not serve. For example, in a case where a given remote UE has discovered two relay UEs where the first relay UE (UE1) serves the requested QoS of the remote UE while the second relay UE (UE2) serves higher QoS levels, the remote UE has a better chance to be served appropriately when choosing to join the relay UE1 that has dedicated E2E Uu DRB and Uu RLC channels for the QoS level it is requesting.
PC5 measurement report information: This PC5 or sidelink measurement report information indicates radio quality of one or more communication links (e.g. PC5 links) between the relay node and at least one remote UE node. The relay UE may perform Sidelink measurements over its PC5 link(s), as defined in TS 38.215, such as SL-RSRP (Reference Signal Receive Power), SL-RSSI (Received Signal Strength Indicator), SL-CR (Channel Occupancy Ratio) and SL-CBR (Channel Busy Ratio). These measurements may show poor radio conditions (e.g. busy channel, interference . . . ) at one or more of its PC5 links. For instance, in UE-to-UE relaying case, a relay UE may include information of PC5 links that would be involved in future communication in between the remote UE and the potential target UEs (identified for instance by dest L2 id in the PC5 measurement report information or in the solicitation message(s) in discovery model B; or identified by a target UE info). A remote UE may thereby choose to ignore candidate relay UE(s) suffering from poor radio conditions over their PC5 link (e.g. the PC5 link to a target UE of the remote UE).
Uu measurement report information: This Uu or network link measurement report information indicates radio quality of a communication link (e.g. Uu link) between the relay node and a network node (e.g. gNB) of the wireless communication system. Different types of measurements over the Uu link may be requested by a gNB or reported periodically by a relay UE. Some of these measurements may be relevant to the candidate remote UE. For example, a relay UE showing a low Uu-RSRP will suffer from reduced bandwidth that may impact some Uu RLC channels and cannot guarantee some uplink/downlink data rates. This information may be optional for a UE-to-UE relay.
Acceptable bitrate information: based on local measurements performed over the Uu link between the relay UE and a network node (e.g. gNB) of the wireless communication system, and/or over its PC5 links, a relay UE may indicate to a remote UE the target bitrate, or the maximum bitrate, it is capable of handling over its Uu link and/or over its PC5 links. For example, this information indicates a maximum bitrate currently supported by the relay UE node.
Network load information: This information indicates the current channel occupancy and so the remaining band for new communication.

The relaying capacity Information Element may be announced by the relay UE (discovery model A) or may be solicited by the remote UE (discovery model B), encompassing L2 and L3 relaying. In this respect, the relaying capacity Information Element may be added to the announcement message (model A) or response message (model B) when performing L2 relaying. Additional announcement (model A) used for L3 relay support may be used to share this information.

The relaying capacity Information Element may also be sent in some dedicated discovery messages, using a new “relay discovery additional information” message type that may rely on the PC5-D protocol stack as defined in 3GPP TS 23.304.

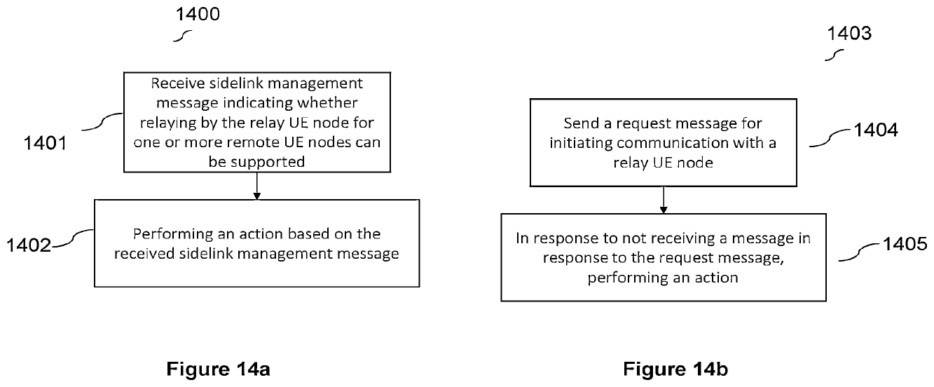

Referring now also to FIGS. 14a and 14b which show steps of methods 1400 and 1403 performed at a remote UE node in a sidelink relay system of a wireless communication system (such as the wireless communication system shown in the FIG. 1 and related Figures) in accordance with embodiments of the invention. For example, FIG. 14a illustrates the steps taken at a remote UE node in response to receiving a a sidelink management message from a relay UE node and FIG. 14b illustrates the steps taken at a remote UE node in response to not receiving a response message in response to a request message sent by the remote UE node. The remote UE node may be one of the remote UEs 101, 102, 103, shown in and described with respect to the Figures and the relay UE node may be relay UE 100 as shown in and described with respect to the Figures. The remote UE node may be implemented in a communication device 1200 as shown in and described with reference to FIG. 12 below with the methods as shown in FIGS. 14a and 14b being performed by the processing unit 1211.

Referring firstly to FIG. 14a, at step 1401, the remote UE node receives, from the relay UE node, a sidelink management message indicating whether relaying by the relay UE node for one or more remote UE nodes can be supported. The sidelink management message may be a discovery message, or a link management message (e.g. a Direct Link message or a Direct Communication message) as discussed above with respect to FIG. 13. The link management message may include relaying capacity information indicating relaying capacity (e.g. the current relaying capacity) of the relay UE node for relaying data by the relay UE node. The relaying capacity information, included in the sidelink management message received from the relay UE node may include one or more of the information included in the relaying capacity Information Element as discussed above. At step, 1402, the remote UE node performs an action based on the received sidelink management message. The performing an action may include, in response to determining, based on the received sidelink management message, relaying by the relay UE node for one or more remote UE nodes cannot be supported, performing (re)selection or a performing a discovery process or a direct link establishment process or a direct communication process for a different relay UE node. The performing an action may include, in response to determining, based on the received relaying capacity information, relaying by the relay UE node for one or more remote UE nodes can be supported, initiating establishment of a connection with the relay UE node (e.g. performing link establishment). When relaying capacity information is included in the sidelink management message with one or more of the information included in the relaying capacity Information Element as discussed above, the remote UE node has additional information to enable the remote UE node to decide whether or not to request a connection with the relay UE node. For example, in a case where the remote UE node has received relaying capacity information from two relay UE nodes, with the first relay UE (UE1) indicating in the relaying capacity information that it serves a level of QoS corresponding to the level of QoS required by the remote UE node and the second relay UE (UE2) indicating in the relaying capacity information that it serves a level of QoS corresponding to higher QoS levels compared to the level of QoS required by the remote UE node, the remote UE has a better chance to be served appropriately when choosing to join the relay UE1 that has dedicated E2E Uu DRB and Uu RLC channels for the QoS level it is requesting. Thus, in this case, the remote UE node may then decide to initiate establishment of a connection with the first relay UE (UE1).

Referring now also to FIG. 14b, at step 1404, the remote UE node, acting as a discoverer UE, sends a request message for initiating communication with a relay UE node. For example, the request message may be a discovery solicitation message for discovering a relay UE node as defined for discovery model B in 3GPP TS 23.304, V17.1.1. The discovery solicitation message may be sent by broadcast or unicast or groupcast. In another example, the request message may be a direct link establishment request message (e.g. as defined in 3GPP TS 24.587, V17.5.0) or a direct communication request (e.g. as defined in 3GPP TS 23.304, V17.1.1). In response to not receiving a message in response to the request message, the remote UE node performs an action, step 1405. For example, the remote UE node may start a timer on sending the request message and if no response message is received within a certain time period as determined by the timer, the remote UE node may then perform an action. The action may include performing (re)selection or performing a discovery process or a direct link establishment process or a direct communication process for a different relay UE node or determining that there is no relay available (e.g. currently) in the vicinity of the remote UE node.

Thus, by identifying the relaying capacity of the relay UE node and determining whether relaying by the relay UE for one or more remote UE nodes can be supported, the relay UE node can check whether there is a risk of a link issue and can proactively act to prevent or allow new connections to one or more new remote UEs and/or modify or release existing connections so as to avoid or minimise the risk of link issues occurring in the future. The relay UE node can proactively act by sending a sidelink management message (such as a discovery message) which indicates whether relaying by the relay UE can be supported (e.g. new connections can be supported/accepted or not) and possibly with some limitations or not. The sidelink management message may include relaying capacity information which provides information indicating the actual or current relaying capacity of the relay UE node. Alternatively, when the relay UE node cannot support relaying for a new or existing remote UE(s) due to a high risk of a link issue in the future, the relay UE node can proactively act by stopping the sidelink management process (e.g. the discovery process) so as to not send or to stop sending sidelink management message (e.g. discovery messages). By not sending or stopping sending the discovery messages, the UEs in the vicinity of the relay UE node will not receive information from the relay UE node. In the case of a discovery process, the UEs in the vicinity of the relay UE node will therefore not consider the relay UE when performing relay (re)selection. On receipt of the sidelink management message including relaying capacity information, the remote UE node can decide, based on the relaying capacity information, what action to take: e.g. whether to request establishment of a connection with the relay UE node or not. When information indicating the actual or current relaying capacity of the relay UE node is included in the discovery message (e.g. one or more of the information included in the relaying capacity Information Element as discussed above are included in the message), the remote UE node has additional information on which to base its decision as to whether to initiate establishment of a connection with the relay UE node. This can help the remote UE node to select the optimum (e.g. based on the required QoS, or bitrate, or link quality, or load requirements) relay UE node to connect to. In the case where the relay UE node does not send or stops sending sidelink management messages, the absence of reception of a response after sending a link management request message (e.g. in the absence of reception of a discovery response message after the sending of a discovery solicitation message), informs the remote UE node that no relay UE node is available (e.g. when the discovery solicitation message is broadcast) or that the targeted relay UE (in case of unicast) suffers from overloading or other limitations which impact the relay UE node's ability to support a new connection to the remote UE node as discussed above.

FIG. 12 shows a schematic representation of an example wireless communication device (apparatus) in accordance with one or more example embodiments of the present disclosure.

The wireless communication device 1200 may preferably be a communication device capable of wireless communication such as a micro-computer or a workstation or a mobile device or a light portable device or a fixed device. The communication device 1200 comprises a communication bus 1213 to which there are preferably connected:
a processing unit 1211, such as a microprocessor, and denoted CPU in FIG. 12. The processing unit 1211 may be a single processing unit or processor or may comprise two or more processing units or processors carrying out the processing required for the operation of the communication device 1200. The number of processors and the allocation of processing functions to the central processing unit 1211 is a matter of design choice for a skilled person;
memory for storing data and computer programs containing instructions for the operation of the communication device 1200. The computer programs may contain a number of different program elements (modules) or sub-routines containing instructions for a variety of operations and for implementing the methods in accordance with one or more embodiments of the invention; and
at least one communication interface 1202 for communicating with other devices or nodes in a wireless communication system, such as a wireless communication system of FIG. 1. The at least one communication interface 1202 may be connected to a communication network 1203, such as a radio access network of the wireless communication system, over which digital data packets or frames or control frames are transmitted.

Each of the relay node and the plurality of nodes (e.g. the remote UEs and the network node) of the sidelink relay arrangement or system may comprise such a communication device 1200.

The memory may include:
a read only memory 1207, denoted ROM, for storing computer programs for implementing the methods in accordance with one or more embodiments of the invention;
a random-access memory 1212, denoted RAM, for storing the executable code of methods according to one or more embodiments of the invention as well as the registers adapted to record variables and parameters necessary for implementing methods according to one or more embodiments of the invention.

Optionally, the communication device 1200 may also include one or more of the following components:
a data storage means 1204 such as a hard disk, for storing computer programs for implementing methods according to one or more embodiments of the invention;
a disk drive 1205 for a disk 1206, the disk drive being adapted to read data from the disk 1206 or to write data onto said disk;
a screen 1209 for displaying decoded data and/or serving as a graphical interface with the user, by means of a keyboard 1210 or any other user input means.

Preferably the communication bus provides communication and interoperability between the various elements included in the communication device 1200 or connected to it. The representation of the bus is not limiting and in particular, the processing unit is operable to communicate instructions to any element of the communication device 1200 directly or by means of another element of the communication device 1200.

The disk 1206 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables methods according to embodiments of the invention to be implemented.

The executable code may optionally be stored either in read only memory 1207, on the hard disk 1204 or on a removable digital medium such as for example a disk 1206 as described previously. According to an optional variant, the executable code of the programs can be received by means of the communication network 1203, via the interface 1202, in order to be stored in one of the storage means of the communication device 1200, such as the hard disk 1204, before being executed.

The processing unit 1211 is preferably adapted to control and direct the execution of the instructions or portions of software code of the program or programs according to the invention, which instructions are stored in one of the aforementioned storage means. Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

While the present invention has been described with reference to embodiments, it is to be understood that the invention is not limited to the disclosed embodiments. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1-19. (canceled)

20. A method for signalling a link issue in a wireless communication system, the wireless communication system comprising a relay User Equipment, UE, node and a plurality of nodes, wherein the plurality of nodes includes a plurality of UEs, the relay UE node for relaying data between a first UE of the plurality of UEs and a second UE of the plurality of UEs using PC5 links established with the relay UE node, the method at the relay UE node including:
after detecting a link issue associated with at least one of a first PC5 link established between the first UE and the relay UE node, and a second PC5 link established between the second UE and the relay UE node, providing link issue feedback information for the detected link issue, the link issue feedback information including information for identifying a type of the detected link issue;
sending the link issue feedback information to at least one of the first UE and the second UE.

21. (canceled)

22. The method of claim 20, further including determining at least one of the plurality of UEs associated with one or more communication flows impacted by the detected link issue, wherein sending the link issue feedback information includes sending the link issue feedback information to the determined at least one of the plurality of UEs.

23. The method of claim 22, wherein the determined at least one of the plurality of UEs includes at least one of a source UE and a destination UE.

24. The method of claim 22, wherein determining at least one of the plurality of UEs associated with the one or more communication flows impacted by the detected link issue comprises using a mapping table to map the one or more impacted communication flows to at least one of the plurality of UEs.

25. The method of claim 20, wherein the link issue feedback information further includes an identifier for identifying the at least one of the first UE and the second UE to which the link issue feedback information is to be sent.

26. (canceled)

27. The method of claim 20, wherein sending the link issue feedback information comprises sending the link issue feedback information to all of the plurality of UEs connected to the relay UE.

28. (canceled)

29. The method of claim 20, wherein the detected link issue is at least one of a plurality of different types of link issue, the plurality of different types of link issue including: handover, congestion, link degradation, Radio Link Failure, RLF.

30. The method of claim 29, wherein the congestion type of link issue includes at least one of: Radio Bearer, RB, congestion; RLC channel congestion; link level congestion; or higher layer congestion.

31. The method of claim 20, wherein the detected link issue is one of a short-term or a long-term issue.

32. The method of claim 20, wherein the link issue feedback information includes flow information for identifying one or more communication flows impacted by the detected link issue, wherein the flow information includes a flow identifier for identifying the one or more communication flows impacted by the detected link issue.

33. The method of claim 20, further comprising determining one or more communication flows impacted by the detected link issue using a mapping table to map the detected link issue to one or more impacted communication flows identified by a respective flow identifier.

34. The method of claim 32, wherein the flow identifier, ID, is one of the following:
Data Radio Bearer, DRB, identifier, ID;
Signalling Radio Bearer, SRB, ID;
Sidelink, SL, DRB ID;
SL SRB ID;
RLC bearer ID;
RLC channel ID;
link ID for identifying a link associated with the detected link issue.

35. The method of claim 20, wherein sending the link issue feedback information comprises sending a link issue signalling message including the link issue feedback information.

36. The method of claim 35, wherein the link issue signalling message is sent in a container, the container including one of:
MAC CE container;
Sidelink Relay Adaptation Protocol, SRAP, control packet data unit, PDU; or
RRC signalling.

37. The method of claim 35, wherein sending the link issue feedback information comprises sending the link issue signalling message by one of unicast communication, or multicast communication or broadcast communication.

38. The method of claim 35, wherein the link issue signalling message includes an Information Element for identifying a type of the detected link issue, and further includes at least one of:
Information Element for identifying one or more communication flows impacted by the detected link issue;
Information Element for indicating a type of the link issue signalling message;
Information Element for identifying the at least one of the plurality of UEs to which the link issue feedback information is to be sent;
Information Element for indicating a reason for the detected link issue;
Information Element for indicating a Quality of Service, QoS, or priority level ensured by the relay UE node;
Information Element for indicating the magnitude or level of the detected link issue.

39. The method of claim 38, wherein the type of the link issue signalling message includes one of: a link issue feedback type; a (re)selection feedback type; or a link status modification feedback type.

40. A method for processing link issue feedback information at a first User Equipment, UE, in a wireless communication system, the link issue feedback information signalling a link issue in the wireless communication system, the wireless communication system including the first UE, a relay UE node and a second UE, the relay UE node for relaying data between the first UE and the second UE using PC5 links, the method including:
receiving link issue feedback information from the relay UE node, the link issue feedback information including information for identifying a type of a detected link issue associated with at least one of a first PC5 link established between the first UE and the relay UE node, and a second PC5 link established between the second UE and the relay UE node and for the at least one of the first PC5 link and the second PC5 link associated with the detected link issue, an identifier of the UE connected to the PC5 link associated with the detected link issue;
processing the link issue feedback information to determine the detected link issue and one or more communication flows impacted by the detected link issue;
based on the detected link issue, taking an action at the first UE.

41. The method of claim 40, wherein the link issue is at least one of a plurality of different types of link issue, the plurality of types of link issue including: handover, congestion, link degradation, RLF, short-term or long-term link issue.

42. The method of claim 40, wherein the link issue feedback information further includes flow information including a flow identifier for identifying the one or more communication flows impacted by the detected link issue.

43. The method of claim 42, wherein the flow identifier, ID, is one of the following:
Data Radio Bearer, DRB, identifier, ID;
Signalling Radio Bearer, SRB, ID;
Sidelink, SL, DRB ID;
SL SRB ID;
RLC bearer ID;
RLC channel ID;
link ID for identifying a link associated with the detected link issue.

44. The method of claim 40, wherein receiving link issue feedback information comprises receiving a link issue signalling message including the link issue feedback information.

45. (canceled)

46. The method of claim 44, wherein the link issue signalling message includes an Information Element for identifying a type of the detected link issue, and further includes at least one of:
Information Element for identifying one or more communication flows impacted by the detected link issue;
Information Element for indicating a type of the link issue signalling message;
Information Element for identifying the UE to which the link issue feedback information is to be sent;
Information Element for indicating a reason for the detected link issue;
Information Element for indicating a Quality of Service, QoS, or priority level ensured by the relay UE node;
Information Element for indicating the magnitude or level of the detected link issue.

47. The method of claim 40, wherein the link issue signalling message includes an Information Element for indicating a type of the link issue signalling message, wherein the type of the link issue signalling message is one of: a link issue feedback type; a (re)selection feedback type; or a link status modification feedback type, wherein taking an action comprises taking an action based on the type of link issue signalling message.

48. (canceled)

49. The method of claim 40, wherein taking an action at the first UE includes one of:
releasing a link associated with the one or more impacted communication flows and performing (re)selection;
waiting for new link issue feedback information;
adapting transmission of data over the one or more impacted communication flows.

50-58. (canceled)

59. A non-transitory computer-readable storage medium carrying a computer program comprising instructions which, when the program is executed by a one or more processing units, cause the one or more processing units to perform a method for signalling a link issue in a wireless communication system, the wireless communication system comprising a relay User Equipment, UE, node and a plurality of nodes, wherein the plurality of nodes includes a plurality of UEs, the relay UE node for relaying data between a first UE of the plurality of UEs and a second UE of the plurality of UEs using PC5 links established with the relay UE node, the method including:
after detecting a link issue associated with at least one of a first PC5 link established between the first UE and the relay UE node, and a second PC5 link established between the second UE and the relay UE node, providing link issue feedback information for the detected link issue, the link issue feedback information including information for identifying a type of the detected link issue;
sending the link issue feedback information to at least one of the first UE and the second UE.

60-64. (canceled)

65. Apparatus for a relay User Equipment, UE, node for a wireless communication system, the relay UE node for relaying data between a first UE of a plurality of UEs of the wireless communication system and a second UE of the plurality of UEs using PC5 links established with the relay UE node, the apparatus comprising:
one or more processing units configured to:
after detecting a link issue associated with at least one of a first PC5 link established between the first UE and the relay UE node, and a second PC5 link established between the second UE and the relay UE node, provide link issue feedback information for the detected link issue, the link issue feedback information including information for identifying a type of the detected link issue;
send the link issue feedback information to at least one of the first UE and the second UE.

66. (canceled)

67. Apparatus for a first User Equipment, UE, for a wireless communication system, the apparatus comprising:
one or more processing units configured to:
receive, from a relay UE node for relaying data between the first UE and a second UE using PC5 links, link issue feedback information signalling a link issue in the wireless communication system, the link issue feedback information including information for identifying a type of a detected link issue associated with at least one of a first PC5 link established between the first UE and the relay UE node, and a second PC5 link established between the second UE and the relay UE node and for the at least one of the first PC5 link and the second PC5 link associated with the detected link issue, an identifier of the UE connected to the PC5 link associated with the detected link issue;
process the link issue feedback information to determine the detected link issue and one or more communication flows impacted by the detected link issue;
based on the detected link issue, take an action at the first UE.

68-73. (canceled)

74. The method of claim 20, wherein the link issue feedback information includes flow information for identifying one or more communication flows impacted by the detected link issue.

75. The method of claim 20, wherein the link issue feedback information includes, for at least one of the first PC5 link and the second PC5 link associated with the detected link issue, an identifier of the UE connected to the PC5 link associated with the detected link issue.

76. The method of claim 75, wherein the identifier of the UE is a L2-ID.

77. The method of claim 20, wherein sending the link issue feedback information comprises sending the link issue feedback information in a PC5-RRC message.

78. The method of claim 40, wherein the link issue feedback information includes flow information for identifying one or more communication flows impacted by the detected link issue.

79. The method of claim 40, wherein the identifier of the UE is a L2-ID.

80. The method of claim 40, wherein sending the link issue feedback information comprises sending the link issue feedback information in a PC5-RRC message.

81. The method of claim 40, wherein taking an action at the first UE includes releasing the one or more impacted communication flows.

82. The method of claim 40, wherein taking an action at the first UE includes performing (re)selection after releasing a link associated with the one or more impacted communication flows.

83. The method of claim 40, wherein taking an action at the first UE includes releasing the first PC5 link in the case where the detected link issue is associated with the first PC5 link.

84. The apparatus of claim 65, wherein the link issue feedback information includes flow information for identifying one or more communication flows impacted by the detected link issue.

85. The apparatus of claim 65, wherein the link issue feedback information includes, for at least one of the first PC5 link and the second PC5 link associated with the detected link issue, an identifier of the UE connected to the PC5 link associated with the detected link issue.

86. The apparatus of claim 85, wherein the identifier of the UE is a L2-ID.

87. The apparatus of claim 65, wherein the one or more processing units are configured to send the link issue feedback information by sending the link issue feedback information in a PC5-RRC message.

88. The apparatus of claim 65, wherein the detected link issue is at least one of a plurality of different types of link issue, the plurality of different types of link issue including: handover, congestion, link degradation, Radio Link Failure, RLF.

89. The apparatus of claim 65, wherein the link issue feedback information includes flow information for identifying one or more communication flows impacted by the detected link issue, wherein the flow information includes a flow identifier for identifying the one or more communication flows impacted by the detected link issue.

90. The apparatus of claim 89, wherein the flow identifier, ID, is one of the following:
Data Radio Bearer, DRB, identifier, ID;
Signalling Radio Bearer, SRB, ID;
Sidelink, SL, DRB ID;
SL SRB ID;
RLC bearer ID;
RLC channel ID;
link ID for identifying a link associated with the detected link issue.

91. The apparatus of claim 67, wherein the link issue feedback information includes flow information for identifying one or more communication flows impacted by the detected link issue.

92. The apparatus of claim 67, wherein the identifier of the UE is a L2-ID.

93. The apparatus of claim 67, wherein the one or more processing units are configured to send the link issue feedback information by sending the link issue feedback information in a PC5-RRC message.

94. The apparatus of claim 67, wherein taking an action at the first UE includes releasing the one or more impacted communication flows.

95. The apparatus of claim 67, wherein taking an action at the first UE includes performing (re)selection after releasing a link associated with the one or more impacted communication flows.

96. The apparatus of claim 67, wherein taking an action at the first UE includes releasing the first PC5 link in the case where the detected link issue is associated with the first PC5 link.

97. The apparatus of claim 67, wherein the link issue is at least one of a plurality of different types of link issue, the plurality of types of link issue including: handover, congestion, link degradation, RLF, short-term or long-term link issue.

98. The apparatus of claim 67, wherein the link issue feedback information further includes flow information including a flow identifier for identifying the one or more communication flows impacted by the detected link issue.

99. The apparatus of claim 98, wherein the flow identifier, ID, is one of the following:
Data Radio Bearer, DRB, identifier, ID;
Signalling Radio Bearer, SRB, ID;
Sidelink, SL, DRB ID;
SL SRB ID;
RLC bearer ID;
RLC channel ID;
link ID for identifying a link associated with the detected link issue.
